(19) United States
(12) Patent Application Publication
(10) Pub. No.: US 2026/0202645 A1
(43) Pub. Date: Jul. 16, 2026

(54) PHOTOGRAPHING OPTICAL LENS ASSEMBLY, IMAGE CAPTURING UNIT AND ELECTRONIC DEVICE

(71) Applicant: LARGAN PRECISION CO., LTD., Taichung City (TW)

(72) Inventors: Kuan-Ting YEH, Taichung City (TW); Cheng-Yu TSAI, Taichung City (TW)

(73) Assignee: LARGAN PRECISION CO., LTD., Taichung City (TW)

(21) Appl. No.: 19/057,310

(22) Filed: Feb. 19, 2025

(30) Foreign Application Priority Data
Jan. 10, 2025 (TW) 114101028

(51) Int. Cl. G02B 13/00; G02B 9/64

(52) U.S. Cl. CPC G02B 13/0045; G02B 9/64

(57) ABSTRACT

A photographing optical lens assembly includes eight lens elements which are, in order from an object side to an image side along an optical path: a first lens element, a second lens element, a third lens element, a fourth lens element, a fifth lens element, a sixth lens element, a seventh lens element and an eighth lens element. The first lens element has negative refractive power. The second lens element has an image-side surface being concave in a paraxial region thereof. The fifth lens element has an object-side surface being convex in a paraxial region thereof. The sixth lens element with negative refractive power has an image-side surface being concave in a paraxial region thereof. The seventh lens element has positive refractive power. The eighth lens element has an image-side surface being concave in a paraxial region thereof and having at least one inflection point.

### RELATED APPLICATIONS

This application claims priority to Taiwan Application 114101028, filed on Jan. 10, 2025, which is incorporated by reference herein in its entirety.

### BACKGROUND

### Technical Field

The present disclosure relates to a photographing optical lens assembly, an image capturing unit and an electronic device, more particularly to a photographing optical lens assembly and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization and a desirable field of view.

### SUMMARY

According to one aspect of the present disclosure, a photographing optical lens assembly includes eight lens elements. The eight lens elements are, in order from an object side to an image side along an optical path, a first lens element, a second lens element, a third lens element, a fourth lens element, a fifth lens element, a sixth lens element, a seventh lens element and an eighth lens element. Each of the eight lens elements has an object-side surface facing toward the object side and an image-side surface facing toward the image side.

Preferably, the first lens element has negative refractive power. Preferably, the image-side surface of the second lens element is concave in a paraxial region thereof. Preferably, the image-side surface of the fourth lens element is convex in a paraxial region thereof. Preferably, the fifth lens element has positive refractive power. Preferably, the object-side surface of the fifth lens element is convex in a paraxial region thereof. Preferably, the image-side surface of the fifth lens element is convex in a paraxial region thereof. Preferably, the sixth lens element has negative refractive power. Preferably, the image-side surface of the sixth lens element is concave in a paraxial region thereof. Preferably, the seventh lens element has positive refractive power. Preferably, the image-side surface of the eighth lens element is concave in a paraxial region thereof. Preferably, the image-side surface of the eighth lens element has at least one inflection point.

When a curvature radius of the object-side surface of the sixth lens element is R11, a curvature radius of the image-side surface of the sixth lens element is R12, an axial distance between the object-side surface of the first lens element and an image surface measured at a reference wavelength of d-line is TLd, a maximum image height of the photographing optical lens assembly is ImgH, a focal length of the photographing optical lens assembly measured at the reference wavelength of d-line is fd, a central thickness of the first lens element is CT1, a central thickness of the third lens element is CT3, a central thickness of the seventh lens element is CT7, and an axial distance between the second lens element and the third lens element is T23, the following conditions are preferably satisfied:

$$0 < ( R 11 + R 12 ) / ( R 11 - R 12 ) < 1.5 ;$$

$$4. < TLd / ImgH < 6.5 ;$$

$$6. < TLd / fd < 12 \text{.00} ;$$

$$0.1 < CT 1 / CT 7 < 0.8 ; and$$

$$0.6 < T 23 / CT 3 < 2.00 .$$

According to another aspect of the present disclosure, a photographing optical lens assembly includes eight lens elements. The eight lens elements are, in order from an object side to an image side along an optical path, a first lens element, a second lens element, a third lens element, a fourth lens element, a fifth lens element, a sixth lens element, a seventh lens element and an eighth lens element. Each of the eight lens elements has an object-side surface facing toward the object side and an image-side surface facing toward the image side.

Preferably, the first lens element has negative refractive power. Preferably, the image-side surface of the second lens element is concave in a paraxial region thereof. Preferably, the fourth lens element has positive refractive power. Preferably, the object-side surface of the fifth lens element is convex in a paraxial region thereof. Preferably, the sixth lens element has negative refractive power. Preferably, the object-side surface of the sixth lens element is concave in a paraxial region thereof. Preferably, the image-side surface of the sixth lens element is concave in a paraxial region thereof. Preferably, the seventh lens element has positive refractive power. Preferably, the image-side surface of the eighth lens element is concave in a paraxial region thereof. Preferably, the image-side surface of the eighth lens element has at least one inflection point.

When a curvature radius of the object-side surface of the first lens element is R1, a curvature radius of the object-side surface of the sixth lens element is R11, a curvature radius of the image-side surface of the sixth lens element is R12, a curvature radius of the object-side surface of the eighth lens element is R15, a curvature radius of the image-side surface of the eighth lens element is R16, an axial distance between the object-side surface of the first lens element and an image surface measured at a reference wavelength of d-line is TLd, a maximum image height of the photographing optical lens assembly is ImgH, a focal length of the photographing optical lens assembly measured at the reference wavelength of d-line is fd, a focal length of the first lens element measured at the reference wavelength of d-line is f1d, a focal length of the second lens element measured at the reference wavelength of d-line is f2d, a focal length of the third lens element measured at the reference wavelength of d-line is f3d, a focal length of the fourth lens element measured at the reference wavelength of d-line is f4d, a focal length of the fifth lens element measured at the reference wavelength of d-line is f5d, a focal length of the sixth lens element measured at the reference wavelength of d-line is f6d, a focal length of the seventh lens element measured at the reference wavelength of d-line is f7d, a focal length of the eighth lens element measured at the reference wavelength of d-line is f8d, and a focal length of the i-th lens element measured at the reference wavelength of d-line is fid, the following conditions are preferably satisfied:

$$0 < ( R 11 + R 12 ) / ( R 11 - R 12 ) < 0.9 ;$$

$$4. < TLd / ImgH < 6.5 ;$$

$$1. < \sum \vert fd / fid \vert < 4. , wherein i = 1 , 2 , 3 , 4 , 5 , 6 , 7 and 8 ;$$

$$0.65 < \vert fd / R 15 \vert + \vert fd / R 16 \vert < 2. ; and$$

$$0.25 < \vert f 1 d / R 1 \vert < 1. .$$

According to another aspect of the present disclosure, an image capturing unit includes one of the aforementioned photographing optical lens assemblies and an image sensor, wherein the image sensor is disposed on the image surface of the photographing optical lens assembly.

According to another aspect of the present disclosure, an electronic device includes the aforementioned image capturing unit.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit according to the 1st embodiment of the present disclosure;

FIG. 2 shows spherical aberration curves, astigmatic field curves and a distortion curve of the image capturing unit according to the 1st embodiment;

FIG. 3 is a schematic view of an image capturing unit according to the 2nd embodiment of the present disclosure;

FIG. 4 shows spherical aberration curves, astigmatic field curves and a distortion curve of the image capturing unit according to the 2nd embodiment;

FIG. 5 is a schematic view of an image capturing unit according to the 3rd embodiment of the present disclosure;

FIG. 6 shows spherical aberration curves, astigmatic field curves and a distortion curve of the image capturing unit according to the 3rd embodiment;

FIG. 7 is a schematic view of an image capturing unit according to the 4th embodiment of the present disclosure;

FIG. 8 shows spherical aberration curves, astigmatic field curves and a distortion curve of the image capturing unit according to the 4th embodiment;

FIG. 9 is a schematic view of an image capturing unit according to the 5th embodiment of the present disclosure;

FIG. 10 shows spherical aberration curves, astigmatic field curves and a distortion curve of the image capturing unit according to the 5th embodiment;

FIG. 11 is a schematic view of an image capturing unit according to the 6th embodiment of the present disclosure;

FIG. 12 shows spherical aberration curves, astigmatic field curves and a distortion curve of the image capturing unit according to the 6th embodiment;

FIG. 13 is a schematic view of an image capturing unit according to the 7th embodiment of the present disclosure;

FIG. 14 shows spherical aberration curves, astigmatic field curves and a distortion curve of the image capturing unit according to the 7th embodiment;

FIG. 15 is a perspective view of an image capturing unit according to the 8th embodiment of the present disclosure;

FIG. 16 is one perspective view of an electronic device according to the 9th embodiment of the present disclosure;

FIG. 17 is another perspective view of the electronic device in FIG. 16;

FIG. 18 is one perspective view of an electronic device according to the 10th embodiment of the present disclosure;

FIG. 19 is another perspective view of the electronic device in FIG. 18;

FIG. 20 is a block diagram of the electronic device in FIG. 18;

FIG. 21 is one perspective view of an electronic device according to the 11th embodiment of the present disclosure;

FIG. 22 is one perspective view of an electronic device according to the 12th embodiment of the present disclosure;

FIG. 23 is a schematic view of an electronic device according to the 13th embodiment of the present disclosure;

FIG. 24 is a perspective view of an electronic device according to the 14th embodiment of the present disclosure;

FIG. 25 is a side view of the electronic device in FIG. 24;

FIG. 26 is a top view of the electronic device in FIG. 24;

FIG. 27 is a schematic view of an electronic device according to the 15th embodiment of the present disclosure;

FIG. 28 is a schematic view of an electronic device according to the 16th embodiment of the present disclosure;

FIG. 29 shows a schematic view of Y1R1d, Y5R1d and Sag2R1d according to the 1st embodiment of the present disclosure;

FIG. 30 shows a schematic view of inflection points on lens surfaces and critical points on lens surfaces according to the 1st embodiment of the present disclosure;

FIG. 31 shows a schematic view of a configuration of a light-folding element in a photographing optical lens assembly according to one embodiment of the present disclosure;

FIG. 32 shows a schematic view of another configuration of a light-folding element in a photographing optical lens assembly according to one embodiment of the present disclosure; and

FIG. 33 shows a schematic view of a configuration of two light-folding elements in a photographing optical lens assembly according to one embodiment of the present disclosure.

### DETAILED DESCRIPTION

A photographing optical lens assembly includes eight lens elements. The eight lens elements are, in order from an object side to an image side along an optical path, a first lens element, a second lens element, a third lens element, a fourth lens element, a fifth lens element, a sixth lens element, a seventh lens element and an eighth lens element. Each of the eight lens elements has an object-side surface facing toward the object side and an image-side surface facing toward the image side.

The first lens element can have negative refractive power. Therefore, it is favorable for increasing the field of view so as to obtain a relatively large range of image information. The object-side surface of the first lens element can be convex in a paraxial region thereof. Therefore, it is favorable for increasing the viewing angle and the image size. The image-side surface of the first lens element can be concave in a paraxial region thereof. Therefore, it is favorable for adjusting the travelling direction of light with a relatively large field of view, thereby reducing generations of glare and stray light.

The second lens element can have negative refractive power. Therefore, it is favorable for assisting in balancing the refractive power of the first lens element, while correcting off-axial aberrations. The object-side surface of the second lens element can be convex in a paraxial region thereof. Therefore, it is favorable for adjusting the lens shape and the refractive power of the second lens element, thereby improving image quality at the central image. The image-side surface of the second lens element can be concave in a paraxial region thereof. Therefore, it is favorable for adjusting the incident angle of light with a relatively large field of view from the object end to the image end of the photographing optical lens assembly, thereby improving convergence quality of light at the periphery.

The third lens element can have positive refractive power. Therefore, it is favorable for assisting in balancing the refractive powers of the first and second lens elements, thereby correcting spherical aberration of the photographing optical lens assembly. The image-side surface of the third lens element can be convex in a paraxial region thereof. Therefore, it is favorable for controlling the travelling direction of light at the periphery of the third lens element, thereby preventing ineffective light convergence due to insufficient deflection of light at the periphery.

The fourth lens element can have positive refractive power. Therefore, it is favorable for converging light. The image-side surface of the fourth lens element can be convex in a paraxial region thereof. Therefore, it is favorable for adjusting the emitting direction of light from the fourth lens element, thereby facilitating enlargement of the image surface.

The fifth lens element can have positive refractive power. Therefore, it is favorable for balancing the refractive powers of the fourth and sixth lens elements, improving convergence quality of light from various fields of view onto the image surface, and correcting aberrations. The object-side surface of the fifth lens element can be convex in a paraxial region thereof. Therefore, it is favorable for balancing the incident angle of light with a relatively large field of view into the fifth lens element, thereby preventing light divergence. The image-side surface of the fifth lens element can be convex in a paraxial region thereof. Therefore, it is favorable for providing light convergence ability for the fifth lens element, thereby preventing stray light due to an overly large incident angle of light at the periphery.

The sixth lens element can have negative refractive power. Therefore, it is favorable for balancing the refractive powers of lens elements at the image end of the photographing optical lens assembly and reducing the back focal length. The object-side surface of the sixth lens element can be concave in a paraxial region thereof. Therefore, it is favorable for correcting field curvature, while reducing the back focal length. The image-side surface of the sixth lens element can be concave in a paraxial region thereof. Therefore, it is favorable for effectively controlling the travelling direction of light with a relatively large field of view and reducing the incident angle of light onto the image surface, thereby increasing illuminance at the peripheral field of view.

The seventh lens element can have positive refractive power. Therefore, it is favorable for converging light to effectively control the direction of optical path, and obtaining a proper balance between the field of view and the size distribution. The object-side surface of the seventh lens element can be convex in a paraxial region thereof. Therefore, it is favorable for adjusting the back focal length in collaboration with the eighth lens element, thereby preventing an overly large size of a lens and thus reducing the difficulty in device size reduction.

The image-side surface of the eighth lens element can be concave in a paraxial region thereof. Therefore, it is favorable for correcting field curvature, while reducing the back focal length.

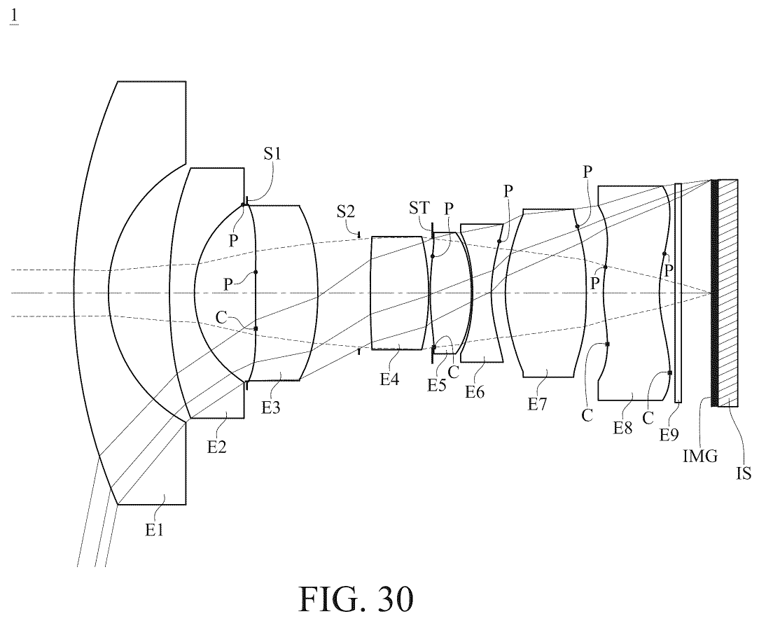

According to the present disclosure, the image-side surface of the eighth lens element can have at least one inflection point. Therefore, it is favorable for enhancing the ability of the eighth lens element in aberration correction at the peripheral image. Please refer to FIG. 30, which shows a schematic view of an inflection point P on the image-side surface of the eighth lens element E8 according to the 1st embodiment of the present disclosure. The abovementioned inflection point P on the image-side surface of the eighth lens element E8, as well as inflection points P on the image-side surface of the second lens element E2, the object-side surface of the third lens element E3, the object-side surface of the fifth lens element E5, the image-side surface of the sixth lens element E6, the image-side surface of the seventh lens element E7 and the object-side surface of the eighth lens element E8 in FIG. 30 are only exemplary. Each of lens surfaces in various embodiments of the present disclosure may also have one or more inflection points.

According to the present disclosure, the image-side surface of the eighth lens element can have at least one critical point in an off-axis region thereof. Therefore, it is favorable for adjusting the light incident angle onto the image surface, controlling the angle of light at the periphery, preventing vignette at the image periphery and correcting distortion. Please refer to FIG. 30, which shows a schematic view of a critical point C on the image-side surface of the eighth lens element E8 according to the 1st embodiment of the present disclosure. The abovementioned critical point C on the image-side surface of the eighth lens element E8, as well as critical points C on the object-side surface of the third lens element E3, the object-side surface of the fifth lens element E5 and the object-side surface of the eighth lens element E8 in FIG. 30 are only exemplary. Each of lens surfaces in various embodiments of the present disclosure may also have one or more critical points in an off-axis region thereof.

According to the present disclosure, the first lens element can be made of glass material. Therefore, a proper selection of glass material is favorable for effectively reducing sensitivity to environmental factors, and the glass material exhibits high stability cross various scenarios, making it resistant to humid environments, preventing surface scratches, and thus effectively extending the life span of applied electronic products.

According to the present disclosure, the eight lens elements can include at least one positive lens element, and an Abbe number of the at least one positive lens element can be smaller than 30.0. Therefore, it is favorable for effectively concentrating convergence positions of light with different wavelengths, thereby increasing image resolution. Moreover, the Abbe number of the at least one positive lens element can also be smaller than 26.0. Moreover, the Abbe number of the at least one positive lens element can also be smaller than 24.0. Moreover, the Abbe number of the at least one positive lens element can also be smaller than 22.0. Moreover, the Abbe number of the at least one positive lens element can also be smaller than 20.0.

When a curvature radius of the object-side surface of the sixth lens element is R11, and a curvature radius of the image-side surface of the sixth lens element is R12, the following condition can be satisfied: 0< (R11+R12)/<1.50. Therefore, it is favorable for effectively balancing the curvature radius of the object-side surface of the sixth lens element and the curvature radius of the image-side surface of the sixth lens element, thereby improving convergence quality of imaging light and effectively correcting field curvature and spherical aberration. Moreover, the following condition can also be satisfied: 0.05< (R11+R12)/<1.30. Moreover, the following condition can also be satisfied: 0.13≤(R11+R12)/≤1.21. Moreover, the following condition can also be satisfied: 0< (R11+R12)/<0.90. Moreover, the following condition can also be satisfied: 0.10< (R11+R12)/<0.70. Moreover, the following condition can also be satisfied: 0.10< (R11+R12)/<0.65. Moreover, the following condition can also be satisfied: 0.20< (R11+R12)/<0.60.

When an axial distance between the object-side surface of the first lens element and the image surface measured at a reference wavelength of d-line is TLd, and a maximum image height of the photographing optical lens assembly (which can be half of a diagonal length of an effective photosensitive area of the image sensor) is ImgH, the following condition can be satisfied: 4.00<TLd/ImgH<6.50. Therefore, it is favorable for obtaining a proper balance between the maintenance of the total track length of the photographing optical lens assembly and enlargement of the image surface. Moreover, the following condition can also be satisfied: 4.50<TLd/ImgH<6.30. Moreover, the following condition can also be satisfied: 4.80<TLd/ImgH<6.15. Moreover, the following condition can also be satisfied: 5.00≤TLd/ImgH≤6.07.

When the axial distance between the object-side surface of the first lens element and the image surface measured at the reference wavelength of d-line is TLd, and a focal length of the photographing optical lens assembly measured at the reference wavelength of d-line is fd, the following condition can be satisfied: 6.00<TLd/fd<12.00. Therefore, it is favorable for obtaining a proper balance between the total track length and the field of view of the photographing optical lens assembly, thereby facilitating formation of a wide-viewing-angle characteristic. Moreover, the following condition can also be satisfied: 7.00<TLd/fd<10.00. Moreover, the following condition can also be satisfied: 7.40<TLd/fd<9.00. Moreover, the following condition can also be satisfied: 7.72≤TLd/fd≤9.56.

When a central thickness of the first lens element is CT1, and a central thickness of the seventh lens element is CT7, the following condition can be satisfied: 0.10<CT1/CT7<0.80. Therefore, it is favorable for balancing the central thicknesses of the first and seventh lens elements, thereby balancing the space arrangement between the lens elements at the object end and the lens elements at the image end of the photographing optical lens assembly. Moreover, the following condition can also be satisfied: 0.20<CT1/CT7<0.65. Moreover, the following condition can also be satisfied: 0.30<CT1/CT7<0.60. Moreover, the following condition can also be satisfied: 0.38≤CT1/CT7≤0.55.

When an axial distance between the second lens element and the third lens element is T23, and a central thickness of the third lens element is CT3, the following condition can be satisfied: 0.60<T23/CT3<2.00. Therefore, it is favorable for adjusting the space ratio of the interval distance between the second and third lens elements to the central thickness of the third lens element so as to provide sufficient space for converging light with a relatively large field of view, thereby improving light convergence quality at the periphery and increasing the field of view. Moreover, the following condition can also be satisfied: 0.70<T23/CT3<1.80. Moreover, the following condition can also be satisfied: 0.75<T23/CT3<1.60. Moreover, the following condition can also be satisfied: 0.81≤T23/CT3≤1.44.

When the focal length of the photographing optical lens assembly measured at the reference wavelength of d-line is fd, a focal length of the first lens element measured at the reference wavelength of d-line is f1d, a focal length of the second lens element measured at the reference wavelength of d-line is f2d, a focal length of the third lens element measured at the reference wavelength of d-line is f3d, a focal length of the fourth lens element measured at the reference wavelength of d-line is f4d, a focal length of the fifth lens element measured at the reference wavelength of d-line is f5d, a focal length of the sixth lens element measured at the reference wavelength of d-line is f6d, a focal length of the seventh lens element measured at the reference wavelength of d-line is f7d, a focal length of the eighth lens element measured at the reference wavelength of d-line is f8d, and a focal length of the i-th lens element measured at the reference wavelength of d-line is fid, the following condition can be satisfied: 1.00<Σ|fd/fid|<4.00, wherein i=1, 2, 3, 4, 5, 6, 7 and 8. Therefore, it is favorable for adjusting the sum of refractive powers of all lens elements so as to prevent excessive aberrations, especially excessive spherical aberration, caused by a relatively large field of view of incident light deflected by an overly strong refractive power, thereby facilitating the enlargement of the field of view and the improvement of convergence quality of light from all fields of view. Moreover, the following condition can also be satisfied: 1.50<Σ|fd/fid|<3.75, wherein i=1, 2, 3, 4, 5, 6, 7 and 8. Moreover, the following condition can also be satisfied: 2.00<Σ|fd/fid|<3.00, wherein i=1, 2, 3, 4, 5, 6, 7 and 8. Moreover, the following condition can also be satisfied: 2.16≤2|fd/fid|≤3.48, wherein i=1, 2, 3, 4, 5, 6, 7 and 8. Please be noted that >|fd/fid| can also be considered as the sum of |fd/f1d|, |fd/f2d|, |fd/f3d|, fd/f4d|, |fd/f5d|, |fd/f6d|, |fd/f7d| and |fd/f8d|.

When the focal length of the photographing optical lens assembly measured at the reference wavelength of d-line is fd, a curvature radius of the object-side surface of the eighth lens element is R15, and a curvature radius of the image-side surface of the eighth lens element is R16, the following condition can be satisfied: 0.65<|fd/R15|+|fd/R16|<2.00. Therefore, it is favorable for effectively balancing the curvature radius of the object-side surface of the eighth lens element and the curvature radius of the image-side surface of the eighth lens element so as to adjust the travelling direction of light at the periphery, thereby correcting astigmatism of the photographing optical lens assembly and reducing stray light in the optical lens. Moreover, the following condition can also be satisfied: 0.80<|fd/R15|+|fd/R16|<1.80. Moreover, the following condition can also be satisfied: 0.90<|fd/R15|+|fd/R16|<1.60. Moreover, the following condition can also be satisfied: 0.97≤|fd/R15|+|fd/R16|≤1.54.

When the focal length of the first lens element measured at the reference wavelength of d-line is f1d, and a curvature radius of the object-side surface of the first lens element is R1, the following condition can be satisfied: 0.25<|f1d/R1|<1.00. Therefore, it is favorable for adjusting the shape variation of the object-side surface of the first lens element so as to ensure the first lens element can have an arrangement effectively controlling the optical path of the photographing optical lens assembly, thereby maintaining the photography viewing angle and increasing incident light amount. Moreover, the following condition can also be satisfied: 0.35<|f1d/R1|<0.85. Moreover, the following condition can also be satisfied: 0.40<|f1d/R1|<0.80. Moreover, the following condition can also be satisfied: 0.43≤|f1d/R1|≤ 0.72.

When the focal length of the second lens element measured at the reference wavelength of d-line is f2d, and the focal length of the sixth lens element measured at the reference wavelength of d-line is f6d, the following condition can be satisfied: 1.50<|f2d/f6d|<4.00. Therefore, it is favorable for adjusting the intensity ratio of the refractive powers of the second and sixth lens elements so as to effectively control the travelling direction of the optical path, thereby reducing light incident angle onto the image surface. Moreover, the following condition can also be satisfied: 1.80<|f2d/f6d|<3.50.

When a curvature radius of the object-side surface of the fifth lens element is R9, and the curvature radius of the image-side surface of the eighth lens element is R16, the following condition can be satisfied: 0< (R9−R16)/(R9+R16)<0.50. Therefore, it is favorable for effectively balancing the curvature radius of the object-side surface of the fifth lens element and the curvature radius of the image-side surface of the eighth lens element, such that the fifth and eighth lens elements can be collaborated with each other to improve image quality at the central image. Moreover, the following condition can also be satisfied: 0.05< (R9−R16)/(R9+R16)<0.45.

When an axial distance between the object-side surface of the first lens element and the image-side surface of the eighth lens element is TD, and an axial distance between the image-side surface of the eighth lens element and the image surface measured at the reference wavelength of d-line is BLd, the following condition can be satisfied: 8.00<TD/BLd<18.00. Therefore, it is favorable for balancing the lens sizes and the back focal length, thereby obtaining a proper balance between the illuminance at the periphery and the lens size. Moreover, the following condition can also be satisfied: 9.00<TD/BLd<16.00.

When an axial distance between the first lens element and the second lens element is T12, and the axial distance between the second lens element and the third lens element is T23, the following condition can be satisfied: 0.20<T12/T23<1.80. Therefore, it is favorable for balancing lens intervals between the first and second lens elements and between the second and third lens elements, allowing sufficient space at the object end for adjusting the travelling direction of the optical path, thereby increasing design flexibility. Moreover, the following condition can also be satisfied: 0.30<T12/T23<1.50.

When the focal length of the photographing optical lens assembly measured at the reference wavelength of d-line is fd, and a central thickness of the eighth lens element is CT8, the following condition can be satisfied: 0.50<fd/CT8<2.00. Therefore, it is favorable for obtaining a proper balance between the assembly tolerance and manufacturability of the eighth lens element. Moreover, the following condition can also be satisfied: 1.00<fd/CT8<1.80.

When an f-number of the photographing optical lens assembly measured at the reference wavelength of d-line is Fnod, the following condition can be satisfied: 1.50<Fnod<2.00. Therefore, it is favorable for obtaining a proper balance between the illuminance and the depth of view, and increasing the light incident amount for improving image quality. Moreover, the following condition can also be satisfied: 1.60<Fnod<1.90. Moreover, the following condition can also be satisfied: 1.70<Fnod<1.80.

When half of a maximum field of view of the photographing optical lens assembly measured at the reference wavelength of d-line is HFOVd, the following condition can be satisfied: 65.0 degrees<HFOVd<90.0 degrees. Therefore, it is favorable for having sufficient imaging range of the optical lens so as to meet the viewing angle requirement of applied devices. Moreover, the following condition can also be satisfied: 70.0 degrees<HFOVd<85.0 degrees.

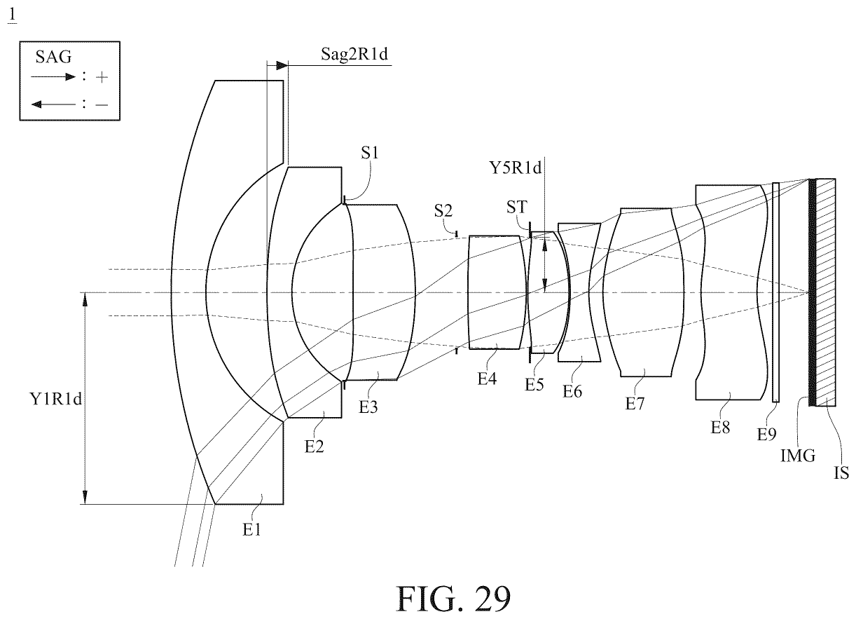

When a displacement in parallel with an optical axis from an axial vertex on the object-side surface of the second lens element to a maximum effective radius position on the object-side surface of the second lens element measured at the reference wavelength of d-line is Sag2R1d, and a central thickness of the second lens element is CT2, the following condition can be satisfied: 0.50<Sag2R1d/CT2<2.50. Therefore, it is favorable for balancing the curved extent of the lens shape at the periphery of the object-side surface of the second lens element so as to eliminate light deflection angle, thereby preventing total reflection. Moreover, the following condition can also be satisfied: 0.80<Sag2R1d/CT2<2.00. Please refer to FIG. 29, which shows a schematic view of Sag2R1d according to the 1st embodiment of the present disclosure. When the direction from the axial vertex of one surface to the maximum effective radius position of the same surface is facing towards the image side of the photographing optical lens assembly, the value of displacement is positive; when the direction from the axial vertex of the surface to the maximum effective radius position of the same surface is facing towards the object side of the photographing optical lens assembly, the value of displacement is negative.

When a maximum effective radius of the object-side surface of the first lens element measured at the reference wavelength of d-line is Y1R1d, and the maximum image height of the photographing optical lens assembly is ImgH, the following condition can be satisfied: 1.50<Y1R1d/ImgH<2.50. Therefore, it is favorable for balancing the effective radius of the object-side surface of the first lens element and the image height so as to adjust the light travelling direction, thereby reducing the incident angle onto the image surface, increasing the illuminance at the peripheral field of view and enlarging the image surface. Moreover, the following condition can also be satisfied: 1.70<Y1R1d/ImgH<2.30. Please refer to FIG. 29, which shows a schematic view of Y1R1d according to the 1st embodiment of the present disclosure.

When the maximum effective radius of the object-side surface of the first lens element measured at the reference wavelength of d-line is Y1R1d, and a maximum effective radius of the object-side surface of the fifth lens element measured at the reference wavelength of d-line is Y5R1d, the following condition can be satisfied: 3.00<Y1R1d/Y5R1d<5.00. Therefore, it is favorable for adjusting the optical effective radii of the first and fifth lens elements so as to balance the travelling direction of light at the image end and to reduce the incident angle onto the image surface, thereby increasing the field of view while increasing illuminance. Moreover, the following condition can also be satisfied: 3.20<Y1R1d/Y5R1d<4.80. Please refer to FIG. 29, which shows a schematic view of Y1R1d and Y5R1d according to the 1st embodiment of the present disclosure.

When a curvature radius of the object-side surface of the third lens element is R5, and a curvature radius of the image-side surface of the third lens element is R6, the following condition can be satisfied: 0.20< (R5+R6)/(R5−R6)<2.00. Therefore, it is favorable for adjusting the curvature radius of the object-side surface of the third lens element and the curvature radius of the image-side surface of the third lens element, thereby converging light while enlarging the image surface. Moreover, the following condition can also be satisfied: 0.35< (R5+R6)/(R5−R6)<1.70.

When the curvature radius of the object-side surface of the sixth lens element is R11, and the focal length of the photographing optical lens assembly measured at the reference wavelength of d-line is fd, the following condition can be satisfied: 1.80<|R11/fd|<5.00. Therefore, it is favorable for effectively balancing the refractive power and the lens shape of the lens element, thereby correcting aberrations of the photographing optical lens assembly and reducing stray light in the optical lens. Moreover, the following condition can also be satisfied: 2.00<|R11/fd|<4.50.

When the central thickness of the first lens element is CT1, and the axial distance between the second lens element and the third lens element is T23, the following condition can be satisfied: 0.10<CT1/T23<1.00. Therefore, it is favorable for balancing the central thickness of the first lens element and the lens interval of the second and third lens elements, thereby improving the space utilization rate and reducing manufacturing tolerance. Moreover, the following condition can also be satisfied: 0.30<CT1/T23<0.75.

When an Abbe number of the second lens element is V2, and an Abbe number of the third lens element is V3, the following condition can be satisfied: 1.40<V2/V3<4.00. Therefore, a proper material configuration of the second and third lens elements is favorable for balancing convergence of light with different wavelengths, especially when applied with the infrared wavelengths. Moreover, the following condition can also be satisfied: 2.00<V2/V3<3.50. Moreover, the following condition can also be satisfied: 2.60<V2/V3<3.20.

When a refractive index of the eighth lens element measured at the reference wavelength of d-line is N8d, the following condition can be satisfied: 1.500<N8d<1.600. Therefore, it is favorable for effectively gathering convergence positions of light with different wavelengths, especially when applied with the infrared wavelengths, so as to prevent overlapped images. Moreover, the following condition can also be satisfied: 1.530<N8d<1.580.

When the curvature radius of the image-side surface of the sixth lens element is R12, a curvature radius of the object-side surface of the seventh lens element is R13, and an axial distance between the sixth lens element and the seventh lens element is T67, the following condition can be satisfied: 0.01<|R12−R13|/T67<10.00. Therefore, it is favorable for adjusting the difference between the curvature radius of the image-side surface of the sixth lens element and the curvature radius of the object-side surface of the seventh lens element, as well as the lens interval along the optical axis between the two lens surfaces, thereby correcting spherical aberration and astigmatism at the image center. Moreover, the following condition can also be satisfied: 0.10<R12−R13|/T67<7.30.

According to the present disclosure, the aforementioned features and conditions can be utilized in numerous combinations so as to achieve corresponding effects.

According to the present disclosure, the lens elements of the photographing optical lens assembly can be made of either glass or plastic material. When the lens elements are made of glass material, the refractive power distribution of the photographing optical lens assembly may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the photographing optical lens assembly can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of refractive power, curvature radius or focus of a lens element is not defined, it indicates that the region of refractive power, curvature radius or focus of the lens element is in the paraxial region thereof.

According to the present disclosure, an inflection point is a point on the surface of the lens element at which the surface changes from concave to convex, or vice versa. A critical point is a non-axial point of the lens surface where its tangent is perpendicular to the optical axis.

According to the present disclosure, the image surface of the photographing optical lens assembly, based on the corresponding image sensor, can be flat or curved, especially a curved surface being concave facing towards the object side of the photographing optical lens assembly.

According to the present disclosure, an image correction unit, such as a field flattener, can be optionally disposed between the lens element closest to the image side of the photographing optical lens assembly along the optical path and the image surface for correction of aberrations such as field curvature. The optical properties of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

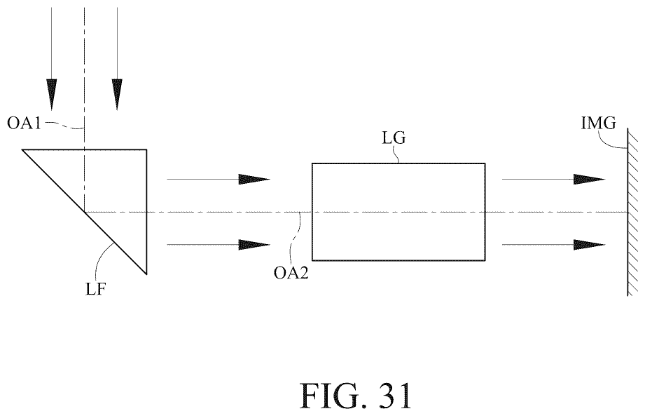

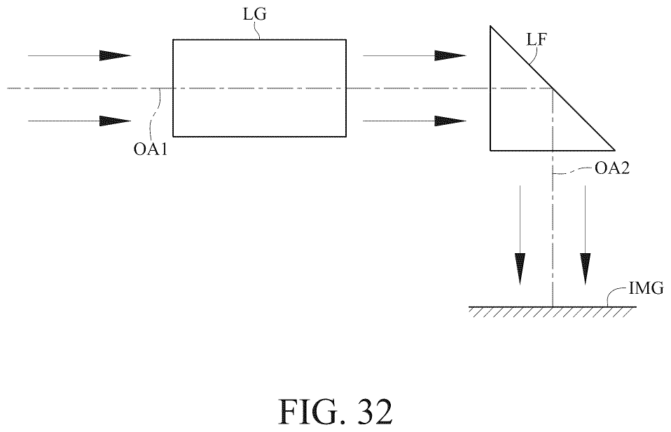

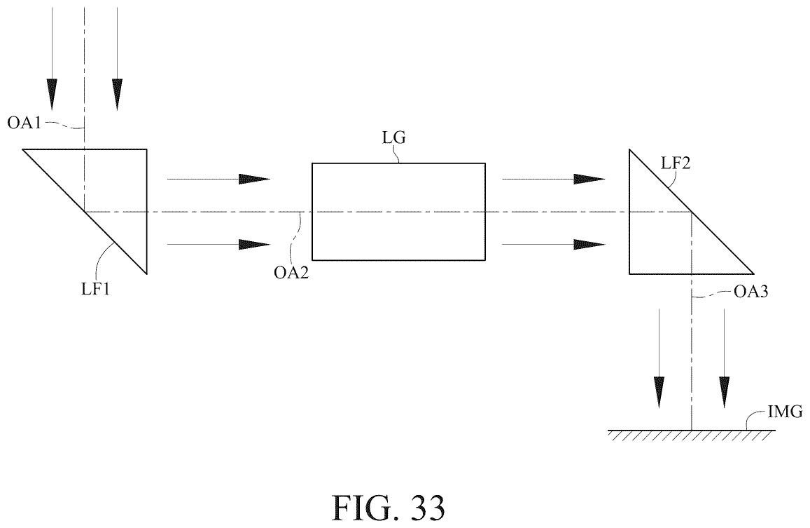

According to the present disclosure, at least one light-folding element, such as a prism or a mirror which can have a surface being planar, spherical, aspheric or in free-form, can be optionally disposed between an imaged object and the image surface on the imaging optical path, such that the photographing optical lens assembly can be more flexible in space arrangement, and therefore the dimensions of an electronic device is not restricted by the total track length of the photographing optical lens assembly. Specifically, please refer to FIG. 31 and FIG. 32. FIG. 31 shows a schematic view of a configuration of a light-folding element in a photographing optical lens assembly according to one embodiment of the present disclosure, and FIG. 32 shows a schematic view of another configuration of a light-folding element in a photographing optical lens assembly according to one embodiment of the present disclosure. In FIG. 31 and FIG. 32, the photographing optical lens assembly can have, in order from an imaged object (not shown in the figures) to an image surface IMG along an optical path, a first optical axis OA1, a light-folding element LF and a second optical axis OA2. The light-folding element LF can be disposed between the imaged object and a lens group LG of the photographing optical lens assembly as shown in FIG. 31 or disposed between a lens group LG of the photographing optical lens assembly and the image surface IMG as shown in FIG. 32. Furthermore, please refer to FIG. 33, which shows a schematic view of a configuration of two light-folding elements in a photographing optical lens assembly according to one embodiment of the present disclosure. In FIG. 33, the photographing optical lens assembly can have, in order from an imaged object (not shown in the figure) to an image surface IMG along an optical path, a first optical axis OA1, a first light-folding element LF1, a second optical axis OA2, a second light-folding element LF2 and a third optical axis OA3. The first light-folding element LF1 is disposed between the imaged object and a lens group LG of the photographing optical lens assembly, the second light-folding element LF2 is disposed between the lens group LG of the photographing optical lens assembly and the image surface IMG, and the travelling direction of light on the first optical axis OA1 can be the same direction as the travelling direction of light on the third optical axis OA3 as shown in FIG. 33. The photographing optical lens assembly can be optionally provided with three or more light-folding elements, and the present disclosure is not limited to the type, amount and position of the light-folding elements of the embodiments disclosed in the aforementioned figures.

According to the present disclosure, the photographing optical lens assembly can include at least one stop, such as an aperture stop, a glare stop or a field stop. Said glare stop or said field stop is set for eliminating the stray light and thereby improving image quality thereof.

According to the present disclosure, an aperture stop can be configured as a front stop or a middle stop. A front stop disposed between an imaged object and the first lens element can provide a longer distance between an exit pupil of the photographing optical lens assembly and the image surface to produce a telecentric effect, and thereby improves the image-sensing efficiency of an image sensor (for example, CCD or CMOS). A middle stop disposed between the first lens element and the image surface is favorable for enlarging the viewing angle of the photographing optical lens assembly and thereby provides a wider field of view for the same.

According to the present disclosure, the photographing optical lens assembly can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the photographing optical lens assembly can include one or more optical elements for limiting the form of light passing through the photographing optical lens assembly. Each optical element can be, but not limited to, a filter, a polarizer, etc., and each optical element can be, but not limited to, a single-piece element, a composite component, a thin film, etc. The optical element can be located at the object side or the image side of the photographing optical lens assembly or between any two adjacent lens elements so as to allow light in a specific form to pass through, thereby meeting application requirements.

According to the present disclosure, the photographing optical lens assembly can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a light-blocking element, an annular spacer, a barrel element, a cover glass, a blue glass, a filter, a color filter, an optical path folding element, a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the photographing optical lens assembly can further include a light-blocking element. The light-blocking element can have a non-circular opening, and the non-circular opening can have different effective radii in different directions which are perpendicular to the optical axis. Therefore, it is favorable for coordinating with the shape of non-circular lens elements or aperture stop so as to effectively save the space and make full use of the light passing through said non-circular lens elements or aperture stop, thereby reducing stray light. Moreover, the light-blocking element can be provided with a wavy structure or a jagged structure at a periphery of an inner hole portion thereof.

According to the present disclosure, the object side and the image side are defined in accordance with the direction of the optical axis, and the axial optical data are calculated along the optical axis. Furthermore, if the optical axis is folded by a light-folding element, the axial optical data are also calculated along the folded optical axis.

According to the above description of the present disclosure, the following specific embodiments are provided for further explanation.

### 1st Embodiment

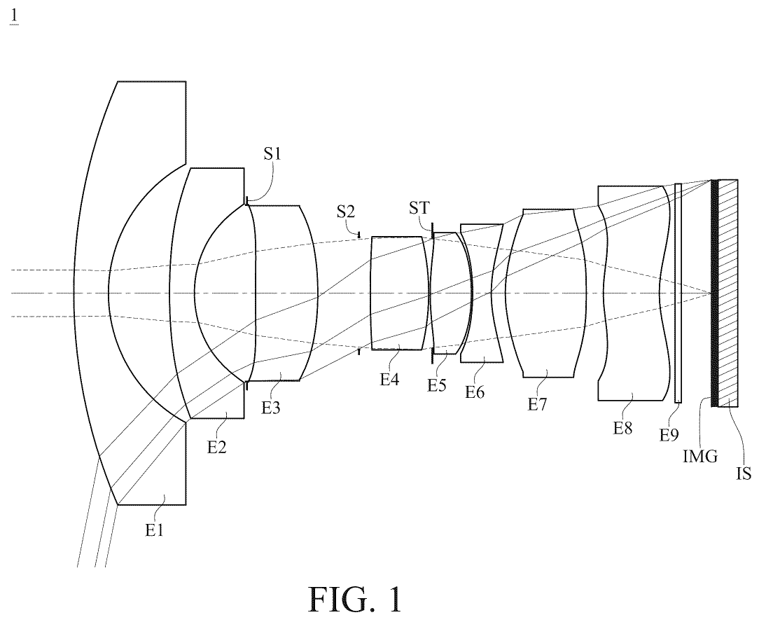

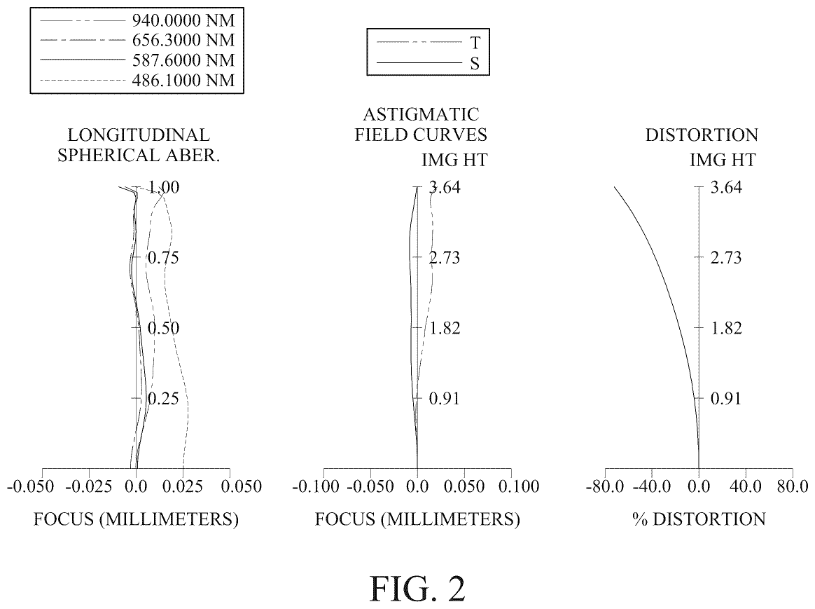

FIG. 1 is a schematic view of an image capturing unit according to the 1st embodiment of the present disclosure. FIG. 2 shows, in order from left to right, spherical aberration curves, astigmatic field curves and a distortion curve of the image capturing unit according to the 1st embodiment. In FIG. 1, the image capturing unit 1 includes the photographing optical lens assembly (its reference numeral is omitted) of the present disclosure and an image sensor IS. The photographing optical lens assembly includes, in order from an object side to an image side along an optical axis, a first lens element E1, a second lens element E2, a stop S1, a third lens element E3, a stop S2, a fourth lens element E4, an aperture stop ST, a fifth lens element E5, a sixth lens element E6, a seventh lens element E7, an eighth lens element E8, a filter E9 and an image surface IMG. The photographing optical lens assembly includes eight lens elements (E1, E2, E3, E4, E5, E6, E7 and E8) with no additional lens element disposed between each of the adjacent eight lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The image-side surface of the second lens element E2 has one inflection point.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has one inflection point. The object-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of glass material and has the object-side surface and the image-side surface being both spherical.

The fifth lens element E5 with positive refractive power has an object-side surface being convex in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The object-side surface of the fifth lens element E5 has one critical point in an off-axis region thereof.

The sixth lens element E6 with negative refractive power has an object-side surface being concave in a paraxial region thereof and an image-side surface being concave in a paraxial region thereof. The sixth lens element E6 is made of plastic material and has the object-side surface and the image-side surface being both aspheric. The image-side surface of the sixth lens element E6 has one inflection point.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The image-side surface of the seventh lens element E7 has one inflection point.

The eighth lens element E8 with positive refractive power has an object-side surface being convex in a paraxial region thereof and an image-side surface being concave in a paraxial region thereof. The eighth lens element E8 is made of plastic material and has the object-side surface and the image-side surface being both aspheric. The object-side surface of the eighth lens element E8 has one inflection point. The image-side surface of the eighth lens element E8 has one inflection point. The object-side surface of the eighth lens element E8 has one critical point in an off-axis region thereof. The image-side surface of the eighth lens element E8 has one critical point in an off-axis region thereof.

The filter E9 is made of plastic material and located between the eighth lens element E8 and the image surface IMG, and will not affect the focal length of the photographing optical lens assembly. The image sensor IS is disposed on or near the image surface IMG of the photographing optical lens assembly.

Among the first lens element E1 to the eighth lens element E8, there is one lens element served as a positive lens element with an Abbe number smaller than 30.0, which is the third lens element E3.

The equation of the aspheric surface profiles of the aforementioned lens elements of the 1st embodiment is expressed as follows:

$$X ( Y ) = ( {Y}^{2} / R ) / ( 1 + s q r t ( 1 - ( 1 + k ) \times {( Y / R )}^{2} ) ) + {\sum }_{i} ( Ai ) \times ( {Y}^{i} )$$

where,
X is the displacement in parallel with an optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12, 14, 16, 18 and 20.

In the photographing optical lens assembly of the image capturing unit according to the 1st embodiment, when a focal length of the photographing optical lens assembly is f, an f-number of the photographing optical lens assembly is Fno, half of a maximum field of view of the photographing optical lens assembly is HFOV, a focal length of the photographing optical lens assembly measured at a reference wavelength of d-line is fd, an f-number of the photographing optical lens assembly measured at the reference wavelength of d-line is Fnod, and half of a maximum field of view of the photographing optical lens assembly measured at the reference wavelength of d-line is HFOVd, these parameters have the following values: f=2.61 millimeters (mm), Fno=1.75, HFOV=78.7 degrees (deg.), fd=2.61 mm, Fnod=1.75, HFOV=79.1 degrees.

When an axial distance between the object-side surface of the first lens element E1 and the image surface IMG measured at the reference wavelength of d-line is TLd, and the focal length of the photographing optical lens assembly measured at the reference wavelength of d-line is fd, the following condition is satisfied: TLd/fd=7.89.

When the axial distance between the object-side surface of the first lens element E1 and the image surface IMG measured at the reference wavelength of d-line is TLd, and a maximum image height of the photographing optical lens assembly (which can be half of a diagonal length of an effective photosensitive area of the image sensor) is ImgH, the following condition is satisfied: TLd/ImgH=5.62.

When an axial distance between the object-side surface of the first lens element E1 and the image-side surface of the eighth lens element E8 is TD, and an axial distance between the image-side surface of the eighth lens element E8 and the image surface IMG measured at the reference wavelength of d-line is BLd, the following condition is satisfied: TD/BLd=11.22.

When the focal length of the photographing optical lens assembly measured at the reference wavelength of d-line is fd, a focal length of the first lens element E1 measured at the reference wavelength of d-line is f1d, a focal length of the second lens element E2 measured at the reference wavelength of d-line is f2d, a focal length of the third lens element E3 measured at the reference wavelength of d-line is f3d, a focal length of the fourth lens element E4 measured at the reference wavelength of d-line is f4d, a focal length of the fifth lens element E5 measured at the reference wavelength of d-line is f5d, a focal length of the sixth lens element E6 measured at the reference wavelength of d-line is f6d, a focal length of the seventh lens element E7 measured at the reference wavelength of d-line is f7d, a focal length of the eighth lens element E8 measured at the reference wavelength of d-line is f8d, and a focal length of the i-th lens element measured at the reference wavelength of d-line is fid, the following condition is satisfied: Σ|fd/fid|=2.73, wherein i=1, 2, 3, 4, 5, 6, 7 and 8. In this embodiment, the total number of lens elements is eight, and therefore Σ|fd/fid|=|fd/f1d|+|fd/f2d|+|fd/f3d|+|fd/f4d|+|fd/f5d|+|fd/f6d|+|fd/f7d|+|fd/f8d|.

When the focal length of the first lens element E1 measured at the reference wavelength of d-line is f1d, and a curvature radius of the object-side surface of the first lens element E1 is R1, the following condition is satisfied: |f1d/R1|=0.48.

When the focal length of the second lens element E2 measured at the reference wavelength of d-line is f2d, and the focal length of the sixth lens element E6 measured at the reference wavelength of d-line is f6d, the following condition is satisfied: |f2d/f6d|=2.31.

When the focal length of the photographing optical lens assembly measured at the reference wavelength of d-line is fd, a curvature radius of the object-side surface of the eighth lens element E8 is R15, and a curvature radius of the image-side surface of the eighth lens element E8 is R16, the following condition is satisfied: |fd/R15|+|fd/R16|=1.26.

When the focal length of the photographing optical lens assembly measured at the reference wavelength of d-line is fd, and a central thickness of the eighth lens element E8 is CT8, the following condition is satisfied: fd/CT8=1.45.

When the curvature radius of the object-side surface of the sixth lens element E6 is R11, and the focal length of the photographing optical lens assembly measured at the reference wavelength of d-line is fd, the following condition is satisfied: R11/fd|=2.52.

When a curvature radius of the object-side surface of the third lens element E3 is R5, and a curvature radius of the image-side surface of the third lens element E3 is R6, the following condition is satisfied: (R5+R6)/(R5−R6)=0.71.

When a curvature radius of the object-side surface of the fifth lens element E5 is R9, and the curvature radius of the image-side surface of the eighth lens element E8 is R16, the following condition is satisfied: (R9−R16)/(R9+R16)=0.34.

When the curvature radius of the object-side surface of the sixth lens element E6 is R11, and a curvature radius of the image-side surface of the sixth lens element E6 is R12, the following condition is satisfied: (R11+R12)/=0.24.

When the curvature radius of the image-side surface of the sixth lens element E6 is R12, a curvature radius of the object-side surface of the seventh lens element E7 is R13, and an axial distance between the sixth lens element E6 and the seventh lens element E7 is T67, the following condition is satisfied: R12-R13|/T67=0.38. In this embodiment, an axial distance between two adjacent lens elements is a distance in a paraxial region between two adjacent lens surfaces of the two adjacent lens elements.

When a central thickness of the first lens element E1 is CT1, and an axial distance between the second lens element E2 and the third lens element E3 is T23, the following condition is satisfied: CT1/T23=0.57.

When the central thickness of the first lens element E1 is CT1, and a central thickness of the seventh lens element E7 is CT7, the following condition is satisfied: CT1/CT7=0.43.

When an axial distance between the first lens element E1 and the second lens element E2 is T12, and the axial distance between the second lens element E2 and the third lens element E3 is T23, the following condition is satisfied: T12/T23=1.00.

When the axial distance between the second lens element E2 and the third lens element E3 is T23, and a central thickness of the third lens element E3 is CT3, the following condition is satisfied: T23/CT3=0.98.

When a refractive index of the eighth lens element E8 measured at the reference wavelength of d-line is N8d, the following condition is satisfied: N8d=1.544.

When an Abbe number of the second lens element E2 is V2, and the Abbe number of the third lens element E3 is V3, the following condition is satisfied: V2/V3=2.87.

When a maximum effective radius of the object-side surface of the first lens element E1 measured at the reference wavelength of d-line is Y1R1d, and a maximum effective radius of the object-side surface of the fifth lens element E5 measured at the reference wavelength of d-line is Y5R1d, the following condition is satisfied: Y1R1d/Y5R1d=3.82.

When the maximum effective radius of the object-side surface of the first lens element E1 measured at the reference wavelength of d-line is Y1R1d, and the maximum image height of the photographing optical lens assembly is ImgH, the following condition is satisfied: Y1R1d/ImgH=1.85.

When a displacement in parallel with the optical axis from an axial vertex on the object-side surface of the second lens element E2 to a maximum effective radius position on the object-side surface of the second lens element E2 measured at the reference wavelength of d-line is Sag2R1d, and a central thickness of the second lens element E2 is CT2, the following condition is satisfied: Sag2R1d/CT2=0.84. In this embodiment, the direction of Sag2R1d points towards the image side of the photographing optical lens assembly, and therefore the value of Sag2R1d is positive.

The detailed optical data of the 1st embodiment are shown in Table 1A to Table 1B and the aspheric surface data are shown in Table 1C below.

TABLE 1A
1st Embodiment
f = 2.61 mm, Fno = 1.75, HFOV = 78.7 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | 17.0787 | (SPH) | 1.114 | Glass | 1.816 | 42.7 | −8.31 |
| 2 | | 4.7135 | (SPH) | 1.964 | | | | |
| 3 | Lens 2 | 17.2895 | (ASP) | 0.800 | Plastic | 1.535 | 56.0 | −8.61 |
| 4 | | 3.5813 | (ASP) | 1.690 | | | | |
| 5 | Stop | Plano | | 0.275 | | | | |
| 6 | Lens 3 | 56.8263 | (ASP) | 2.000 | Plastic | 1.641 | 19.5 | 12.79 |
| 7 | | −9.4486 | (ASP) | 1.321 | | | | |
| 8 | Stop | Plano | | 0.366 | | | | |
| 9 | Lens 4 | 31.3139 | (SPH) | 1.875 | Glass | 1.787 | 46.6 | 7.77 |
| 10 | | −7.4074 | (SPH) | 0.118 | | | | |
| 11 | Ape. Stop | Plano | | −0.068 | | | | |
| 12 | Lens 5 | 8.0869 | (ASP) | 1.323 | Plastic | 1.536 | 56.1 | 6.23 |
| 13 | | −5.3700 | (ASP) | 0.040 | | | | |
| 14 | Lens 6 | −6.5783 | (ASP) | 0.600 | Plastic | 1.641 | 19.5 | −3.82 |
| 15 | | 4.0470 | (ASP) | 0.452 | | | | |
| 16 | Lens 7 | 4.2207 | (ASP) | 2.600 | Plastic | 1.536 | 56.1 | 7.03 |
| 17 | | −27.5827 | (ASP) | 0.549 | | | | |
| 18 | Lens 8 | 4.2774 | (ASP) | 1.800 | Plastic | 1.535 | 56.0 | 90.65 |
| 19 | | 4.0027 | (ASP) | 0.500 | | | | |

| | | | | | | | |
|---|---|---|---|---|---|---|---|
| 20 | Filter | Plano | 0.210 | Plastic | 1.508 | 64.2 | — |
| 21 | | Plano | 0.966 | | | | |
| 22 | Image | Plano | — | | | | |

Note:
Reference wavelength is 940.0 nm.
An effective radius of the stop S1 (Surface 5) is 2.835 mm.
An effective radius of the stop S2 (Surface 8) is 1.802 mm.

TABLE 1B
1st Embodiment
Note: Reference wavelength is 587.6 nm (d-line).
fd = 2.61 mm, Fnod = 1.75, HFOVd = 79.1 deg., TLd = 20.496 mm

| Element | Index | Focal Length |
|---|---|---|
| Lens 1 | 1.835 | −8.13 |
| Lens 2 | 1.544 | −8.48 |
| Lens 3 | 1.669 | 12.26 |
| Lens 4 | 1.804 | 7.62 |
| Lens 5 | 1.545 | 6.13 |
| Lens 6 | 1.669 | −3.66 |
| Lens 7 | 1.545 | 6.92 |
| Lens 8 | 1.544 | 87.53 |
| Filter | 1.517 | — |

TABLE 1C
Aspheric Coefficients

| Surface # | 3 | 4 | 6 | 7 |
|---|---|---|---|---|
| k= | 0.00000E+00 | 0.00000E+00 | 0.00000E+00 | 0.00000E+00 |
| A4= | 1.4125781E−03 | 2.3254274E−03 | −3.0407523E−03 | −2.6680430E−03 |
| A6= | −2.3127132E−04 | −3.6758904E−04 | −2.3155908E−04 | −7.3631203E−05 |
| A8= | 5.9877877E−05 | 2.2542160E−04 | 4.8427085E−05 | 2.0708483E−05 |
| A10= | −7.6554323E−06 | −6.9804930E−05 | −1.2000075E−05 | −5.4581930E−06 |
| A12= | 4.9564700E−07 | 1.8041578E−05 | 1.2608606E−06 | 7.8201119E−07 |
| A14= | −1.6196908E−08 | −3.1008477E−06 | −7.5461960E−08 | −5.4156200E−08 |
| A16= | 2.1531246E−10 | 2.7954640E−07 | 2.1716096E−09 | 1.5316478E−09 |
| A18= | — | −1.0144912E−08 | — | — |
| Surface # | 12 | 13 | 14 | 15 |
| k= | 0.00000E+00 | 0.00000E+00 | 0.00000E+00 | −1.00000E+00 |
| A4= | −6.2056008E−03 | 2.0896272E−03 | −3.7611656E−03 | −2.4109834E−02 |
| A6= | 2.3250887E−03 | −1.6084897E−03 | 6.6030254E−03 | 1.5411688E−02 |
| A8= | −4.7757660E−03 | −9.0488379E−03 | −1.3033824E−02 | −9.7232735E−03 |
| A10= | 4.6818125E−03 | 7.7205332E−03 | 8.4158951E−03 | 4.1406906E−03 |
| A12= | −2.7251540E−03 | −2.7724284E−03 | −2.4822521E−03 | −1.1458586E−03 |
| A14= | 9.1171656E−04 | 4.7575274E−04 | 2.9305485E−04 | 1.9884293E−04 |
| A16= | −1.6303737E−04 | −3.2398302E−05 | 5.6535571E−06 | −2.0243761E−05 |
| A18= | 1.1964652E−05 | — | −2.8803553E−06 | 1.0413935E−06 |
| A20= | — | — | — | −1.8080659E−08 |
| Surface # | 16 | 17 | 18 | 19 |
| k= | 0.00000E+00 | 0.00000E+00 | 0.00000E+00 | 0.00000E+00 |
| A4= | −1.7883147E−02 | −2.7496442E−02 | −3.6806359E−02 | −1.6911641E−02 |
| A6= | 6.3993184E−03 | 8.2540527E−03 | 4.6991602E−03 | −7.4127628E−04 |
| A8= | −2.3309156E−03 | −1.8724746E−03 | −4.9185195E−04 | 6.8644782E−04 |
| A10= | 6.2616360E−04 | 3.6510771E−04 | 6.2151349E−05 | −1.5137602E−04 |
| A12= | −1.1836733E−04 | −5.7382471E−05 | −1.5219297E−05 | 1.7941454E−05 |
| A14= | 1.5145579E−05 | 6.3076568E−06 | 2.2650679E−06 | −1.2803985E−06 |
| A16= | −1.1593135E−06 | −3.9031731E−07 | −1.5398348E−07 | 5.1795613E−08 |
| A18= | 3.9226678E−08 | 1.0057344E−08 | 3.7716693E−09 | −9.1540853E−10 |

In Table 1A, the curvature radius, the thickness and the focal length are shown in millimeters (mm). Surface numbers 0-22 represent the surfaces sequentially arranged from the object side to the image side along the optical axis. In Table 1B, the refractive index and the focal length of each element in the photographing optical lens assembly of the 1st embodiment are measured at the reference wavelength of 587.6 nm (d-line). Please be noted that the photographing optical lens assembly of the 1 st embodiment is applicable to the usage scenario with infrared light band, the usage scenario with visible light band, or the usage scenario including both the infrared light band and the visible light band. In Table 1C, k represents the conic coefficient of the equation of the aspheric surface profiles. A4-A20 represent the aspheric coefficients ranging from the 4th order to the 20th order. The tables presented below for each embodiment are the corresponding schematic parameter and aberration curves, and the definitions of the tables are the same as Table 1A, Table 1B and Table 1C of the 1st embodiment. Therefore, an explanation in this regard will not be provided again.

### 2nd Embodiment

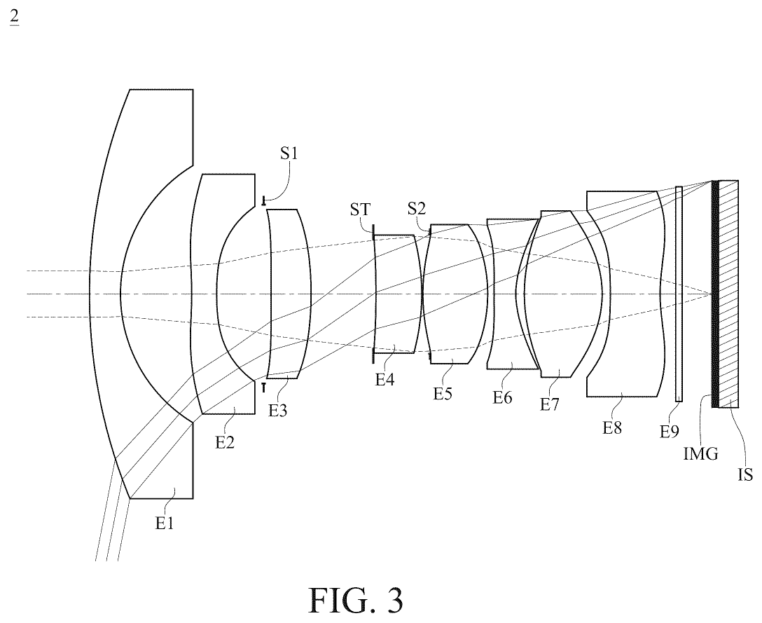

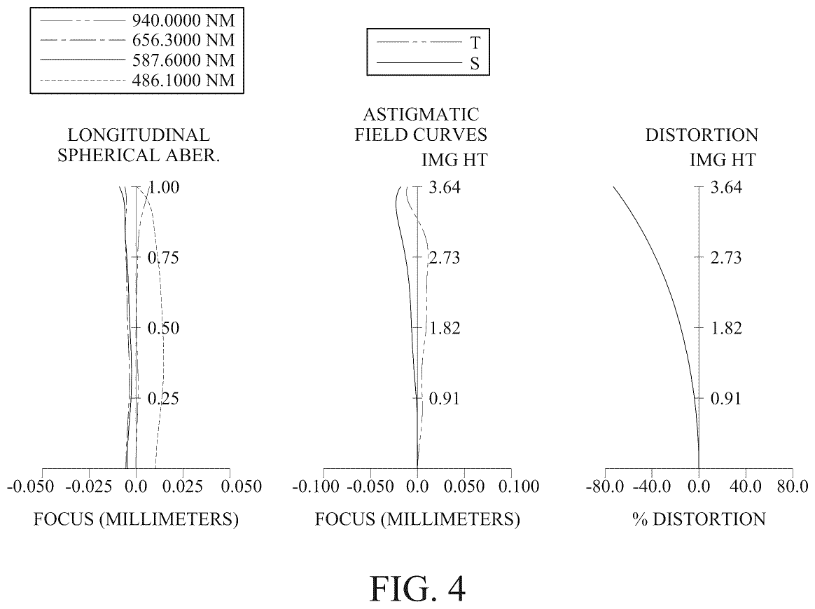

FIG. 3 is a schematic view of an image capturing unit according to the 2nd embodiment of the present disclosure. FIG. 4 shows, in order from left to right, spherical aberration curves, astigmatic field curves and a distortion curve of the image capturing unit according to the 2nd embodiment. In FIG. 3, the image capturing unit 2 includes the photographing optical lens assembly (its reference numeral is omitted) of the present disclosure and an image sensor IS. The photographing optical lens assembly includes, in order from an object side to an image side along an optical axis, a first lens element E1, a second lens element E2, a stop S1, a third lens element E3, an aperture stop ST, a fourth lens element E4, a stop S2, a fifth lens element E5, a sixth lens element E6, a seventh lens element E7, an eighth lens element E8, a filter E9 and an image surface IMG. The photographing optical lens assembly includes eight lens elements (E1, E2, E3, E4, E5, E6, E7 and E8) with no additional lens element disposed between each of the adjacent eight lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The object-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has one inflection point. The object-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of glass material and has the object-side surface and the image-side surface being both spherical.

The fifth lens element E5 with positive refractive power has an object-side surface being convex in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The object-side surface of the sixth lens element E6 has one critical point in an off-axis region thereof.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The image-side surface of the seventh lens element E7 has one inflection point.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The image-side surface of the eighth lens element E8 has one inflection point. The image-side surface of the eighth lens element E8 has one critical point in an off-axis region thereof.

The filter E9 is made of plastic material and located between the eighth lens element E8 and the image surface IMG, and will not affect the focal length of the photographing optical lens assembly. The image sensor IS is disposed on or near the image surface IMG of the photographing optical lens assembly.

Among the first lens element E1 to the eighth lens element E8, there is one lens element served as a positive lens element with an Abbe number smaller than 30.0, which is the third lens element E3.

The detailed optical data of the 2nd embodiment are shown in Table 2A to Table 2B and the aspheric surface data are shown in Table 2C below.

TABLE 2A
2nd Embodiment
f = 2.60 mm, Fno = 1.75, HFOV = 79.0 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | 17.2646 | (SPH) | 0.996 | Glass | 1.787 | 46.6 | −8.82 |
| 2 | | 4.8274 | (SPH) | 2.289 | | | | |
| 3 | Lens 2 | −11.3426 | (ASP) | 0.802 | Plastic | 1.553 | 37.4 | −8.93 |
| 4 | | 8.9506 | (ASP) | 1.509 | | | | |
| 5 | Stop | Plano | | 0.238 | | | | |
| 6 | Lens 3 | 200.0000 | (ASP) | 1.287 | Plastic | 1.641 | 19.5 | 15.78 |
| 7 | | −10.6345 | (ASP) | 2.000 | | | | |
| 8 | Ape. Stop | Plano | | 0.086 | | | | |
| 9 | Lens 4 | −24.8700 | (SPH) | 1.466 | Glass | 1.772 | 47.5 | 12.58 |
| 10 | | −7.1650 | (SPH) | 0.262 | | | | |
| 11 | Stop | Plano | | −0.222 | | | | |
| 12 | Lens 5 | 6.2501 | (ASP) | 2.082 | Plastic | 1.535 | 56.0 | 5.41 |
| 13 | | −4.7710 | (ASP) | 0.203 | | | | |
| 14 | Lens 6 | 27.8691 | (ASP) | 0.701 | Plastic | 1.641 | 19.5 | −4.59 |
| 15 | | 2.6380 | (ASP) | 0.274 | | | | |
| 16 | Lens 7 | 5.1761 | (ASP) | 2.500 | Plastic | 1.535 | 56.0 | 4.22 |
| 17 | | −3.3395 | (ASP) | 0.262 | | | | |
| 18 | Lens 8 | −19.9042 | (ASP) | 1.600 | Plastic | 1.593 | 25.6 | −6.72 |
| 19 | | 5.1373 | (ASP) | 0.500 | | | | |

| | | | | | | | |
|---|---|---|---|---|---|---|---|
| 20 | Filter | Plano | 0.210 | Plastic | 1.508 | 64.2 | — |
| 21 | | Plano | 0.958 | | | | |
| 22 | Image | Plano | — | | | | |

Note:
Reference wavelength is 940.0 nm.
An effective radius of the stop S1 (Surface 5) is 2.870 mm.
An effective radius of the stop S2 (Surface 11) is 1.917 mm.

TABLE 2B
2nd Embodiment
Note: Reference wavelength is 587.6 nm (d-line).
fd = 2.59 mm, Fnod = 1.75, HFOVd = 79.5 deg., TLd = 19.998 mm

| Element | Index | Focal Length |
|---|---|---|
| Lens 1 | 1.804 | −8.64 |
| Lens 2 | 1.566 | −8.71 |
| Lens 3 | 1.669 | 15.13 |
| Lens 4 | 1.788 | 12.32 |
| Lens 5 | 1.544 | 5.33 |
| Lens 6 | 1.669 | −4.40 |
| Lens 7 | 1.544 | 4.16 |
| Lens 8 | 1.614 | −6.50 |
| Filter | 1.517 | — |

TABLE 2C
Aspheric Coefficients

| Surface # | 3 | 4 | 6 | 7 |
|---|---|---|---|---|
| k= | 0.00000E+00 | 0.00000E+00 | 0.00000E+00 | 0.00000E+00 |
| A4= | 1.5825334E−02 | 1.8480206E−02 | −2.3545495E−03 | −1.6397641E−03 |
| A6= | −2.2712505E−03 | −1.3942102E−03 | 6.2839838E−05 | 1.9510300E−05 |
| A8= | 2.6246931E−04 | −5.8770715E−05 | −9.7673331E−05 | −3.4102028E−05 |
| A10= | −2.2552998E−05 | 5.5228680E−05 | 3.0661513E−05 | 8.9551912E−06 |
| A12= | 1.3118197E−06 | −8.2183377E−06 | −4.9745374E−06 | −9.4540983E−07 |
| A14= | −4.5126305E−08 | 2.3761882E−07 | 4.6462891E−07 | 1.0890776E−08 |
| A16= | 6.7981676E−10 | 6.5207387E−08 | −2.1849422E−08 | 1.5191151E−09 |
| A18= | — | −5.1488140E−09 | — | — |
| Surface # | 12 | 13 | 14 | 15 |
| k= | 0.00000E+00 | 0.00000E+00 | 0.00000E+00 | −1.00000E+00 |
| A4= | −1.2457158E−03 | −2.5279428E−03 | −3.3198399E−02 | −3.6335845E−02 |
| A6= | −6.3288237E−04 | 4.0739021E−03 | 1.5026745E−02 | 1.4129968E−02 |
| A8= | 2.6875160E−04 | −2.4361799E−03 | −5.8802252E−03 | −4.7485079E−03 |
| A10= | −2.2280855E−04 | 6.3427063E−04 | 1.5604141E−03 | 1.3379779E−03 |
| A12= | 1.0558999E−04 | −9.8597019E−05 | −3.1421745E−04 | −3.2096502E−04 |
| A14= | −3.3224279E−05 | 8.9728492E−06 | 4.8645318E−05 | 5.9456367E−05 |
| A16= | 5.6123244E−06 | −3.8995153E−07 | −4.7511588E−06 | −7.3828729E−06 |
| A18= | −3.9685350E−07 | — | 2.0281436E−07 | 5.3542658E−07 |
| A20= | — | — | — | −1.7330065E−08 |
| Surface # | 16 | 17 | 18 | 19 |
| k= | 0.00000E+00 | 0.00000E+00 | 0.00000E+00 | 0.00000E+00 |
| A4= | −1.6972651E−03 | 2.3863256E−03 | −2.2062792E−02 | −2.5827951E−02 |
| A6= | −1.2365735E−03 | 2.9354357E−03 | 6.2615722E−03 | 5.1245392E−03 |
| A8= | 6.7062580E−04 | −1.5959475E−03 | −2.6498095E−03 | −1.2029093E−03 |
| A10= | −1.8317366E−04 | 4.5976894E−04 | 7.4054118E−04 | 2.0780921E−04 |
| A12= | 3.0586965E−05 | −7.3934909E−05 | −1.2593741E−04 | −2.3909353E−05 |
| A14= | −4.3418460E−06 | 6.8060257E−06 | 1.2741613E−05 | 1.7364525E−06 |
| A16= | 5.1848971E−07 | −3.3866960E−07 | −6.9439487E−07 | −7.1692553E−08 |
| A18= | −2.8568440E−08 | 8.0426950E−09 | 1.5378050E−08 | 1.2729237E−09 |

In the 2nd embodiment, the equation of the aspheric surface profiles of the aforementioned lens elements is the same as the equation of the 1st embodiment. Also, the definitions of these parameters shown in Table 2D are the same as those stated in the 1st embodiment with corresponding values for the 2nd embodiment, so an explanation in this regard will not be provided again.

Moreover, these parameters can be calculated from Table 2A, Table 2B and Table 2C as the following values and satisfy the following conditions:

TABLE 2D
Schematic Parameters

| | | | |
|---|---|---|---|
| fd [mm] | 2.59 | (R9 − R16)/(R9 + R16) | 0.10 |
| Fnod | 1.75 | (R11 + R12)/(R11 − R12) | 1.21 |
| HFOVd [deg.] | 79.5 | \|R12 − R13\|/T67 | 9.26 |
| TLd/fd | 7.73 | CT1/T23 | 0.57 |
| TLd/ImgH | 5.49 | CT1/CT7 | 0.40 |
| TD/BLd | 11.03 | T12/T23 | 1.31 |
| Σ\|fd/fid\| | 3.07 | T23/CT3 | 1.36 |
| \|f1d/R1\| | 0.50 | N8d | 1.614 |
| \|f2d/f6d\| | 1.98 | V2/V3 | 1.92 |
| \|fd/R15\| + \|fd/R16\| | 0.63 | Y1R1d/Y5R1d | 3.39 |
| fd/CT8 | 1.62 | Y1R1d/ImgH | 1.80 |
| \|R11/fd\| | 10.77 | Sag2R1d/CT2 | 0.42 |
| (R5 + R6)/(R5 − R6) | 0.90 | — | — |

### 3rd Embodiment

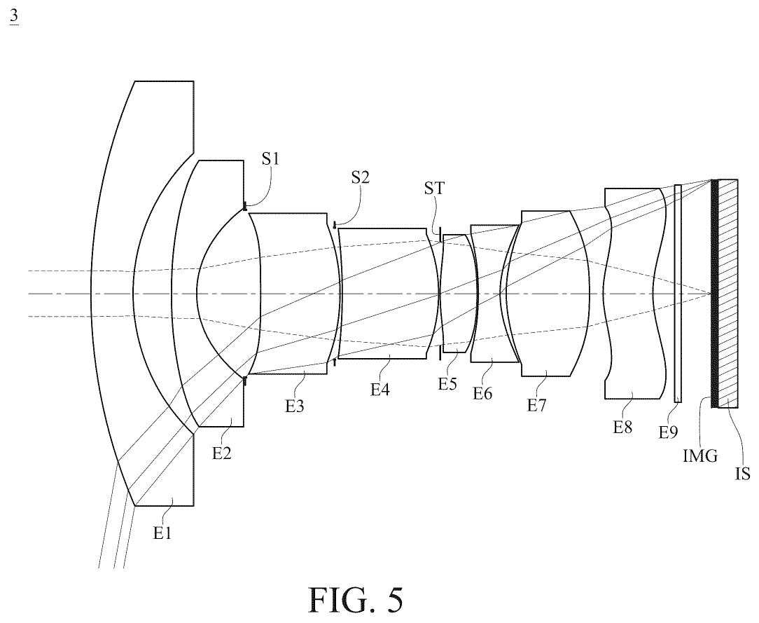

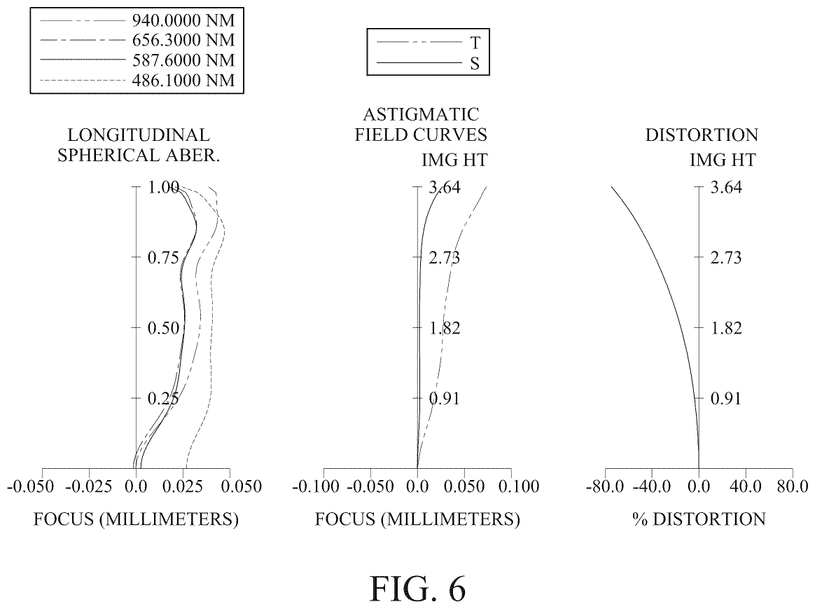

FIG. 5 is a schematic view of an image capturing unit according to the 3rd embodiment of the present disclosure. FIG. 6 shows, in order from left to right, spherical aberration curves, astigmatic field curves and a distortion curve of the image capturing unit according to the 3rd embodiment. In FIG. 5, the image capturing unit 3 includes the photographing optical lens assembly (its reference numeral is omitted) of the present disclosure and an image sensor IS. The photographing optical lens assembly includes, in order from an object side to an image side along an optical axis, a first lens element E1, a second lens element E2, a stop S1, a third lens element E3, a stop S2, a fourth lens element E4, an aperture stop ST, a fifth lens element E5, a sixth lens element E6, a seventh lens element E7, an eighth lens element E8, a filter E9 and an image surface IMG. The photographing optical lens assembly includes eight lens elements (E1, E2, E3, E4, E5, E6, E7 and E8) with no additional lens element disposed between each of the adjacent eight lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The image-side surface of the third lens element E3 has one inflection point.

The fourth lens element E4 with positive refractive power has an object-side surface being concave in a paraxial region thereof and an image-side surface being convex in a paraxial region thereof. The fourth lens element E4 is made of glass material and has the object-side surface and the image-side surface being both spherical.

The fifth lens element E5 with positive refractive power has an object-side surface being convex in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof.

The sixth lens element E6 with negative refractive power has an object-side surface being concave in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The image-side surface of the seventh lens element E7 has one inflection point.

The eighth lens element E8 with positive refractive power has an object-side surface being convex in a paraxial region thereof and an image-side surface being concave in a paraxial region thereof. The eighth lens element E8 is made of plastic material and has the object-side surface and the image-side surface being both aspheric. The object-side surface of the eighth lens element E8 has one inflection point. The image-side surface of the eighth lens element E8 has one inflection point. The object-side surface of the eighth lens element E8 has one critical point in an off-axis region thereof. The image-side surface of the eighth lens element E8 has one critical point in an off-axis region thereof.

The filter E9 is made of plastic material and located between the eighth lens element E8 and the image surface IMG, and will not affect the focal length of the photographing optical lens assembly. The image sensor IS is disposed on or near the image surface IMG of the photographing optical lens assembly.

Among the first lens element E1 to the eighth lens element E8, there is one lens element served as a positive lens element with an Abbe number smaller than 30.0, which is the third lens element E3.

The detailed optical data of the 3rd embodiment are shown in Table 3A to Table 3B and the aspheric surface data are shown in Table 3C below.

TABLE 3A
3rd Embodiment
f = 2.59 mm, Fno = 1.75, HFOV = 79.8 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | 17.1634 | (SPH) | 1.354 | Glass | 1.816 | 42.7 | −12.63 |
| 2 | | 6.2141 | (SPH) | 1.235 | | | | |
| 3 | Lens 2 | 16.1683 | (ASP) | 0.811 | Plastic | 1.535 | 56.0 | −7.17 |
| 4 | | 3.0479 | (ASP) | 1.555 | | | | |
| 5 | Stop | Plano | | 0.500 | | | | |
| 6 | Lens 3 | −86.4198 | (ASP) | 2.550 | Plastic | 1.641 | 19.5 | 11.32 |
| 7 | | −6.7729 | (ASP) | −0.174 | | | | |
| 8 | Stop | Plano | | 0.247 | | | | |
| 9 | Lens 4 | −16.4833 | (SPH) | 3.095 | Glass | 1.787 | 46.6 | 7.74 |
| 10 | | −4.8179 | (SPH) | 0.053 | | | | |
| 11 | Ape. Stop | Plano | | −0.003 | | | | |
| 12 | Lens 5 | 6.5827 | (ASP) | 1.186 | Plastic | 1.536 | 56.1 | 6.99 |
| 13 | | −8.1536 | (ASP) | 0.040 | | | | |
| 14 | Lens 6 | −8.1528 | (ASP) | 0.700 | Plastic | 1.641 | 19.5 | −3.42 |
| 15 | | 3.1050 | (ASP) | 0.199 | | | | |
| 16 | Lens 7 | 4.0681 | (ASP) | 2.675 | Plastic | 1.536 | 56.1 | 6.24 |
| 17 | | −14.5739 | (ASP) | 0.437 | | | | |
| 18 | Lens 8 | 3.1451 | (ASP) | 1.600 | Plastic | 1.535 | 56.0 | 20.79 |
| 19 | | 3.6064 | (ASP) | 0.700 | | | | |

| | | | | | | | |
|---|---|---|---|---|---|---|---|
| 20 | Filter | Plano | 0.210 | Plastic | 1.508 | 64.2 | — |
| 21 | | Plano | 0.974 | | | | |
| 22 | Image | Plano | — | | | | |

Note:
Reference wavelength is 940.0 nm.
An effective radius of the stop S1 (Surface 5) is 2.690 mm.
An effective radius of the stop S2 (Surface 8) is 2.119 mm.

TABLE 3B
3rd Embodiment
Note: Reference wavelength is 587.6 nm (d-line).
fd = 2.58 mm, Fnod = 1.75, HFOVd = 80.0 deg., TLd = 19.947 mm

| Element | Index | Focal Length |
|---|---|---|
| Lens 1 | 1.835 | −12.36 |
| Lens 2 | 1.544 | −7.06 |
| Lens 3 | 1.669 | 10.84 |
| Lens 4 | 1.804 | 7.57 |
| Lens 5 | 1.545 | 6.88 |
| Lens 6 | 1.669 | −3.28 |
| Lens 7 | 1.545 | 6.15 |
| Lens 8 | 1.544 | 20.34 |
| Filter | 1.517 | — |

TABLE 3C
Aspheric Coefficients

| Surface # | 3 | 4 | 6 | 7 |
|---|---|---|---|---|
| k= | 0.00000E+00 | 0.00000E+00 | 0.00000E+00 | 0.00000E+00 |
| A4= | 3.4602830E−03 | 3.8962910E−03 | −6.8128403E−03 | −3.6681837E−03 |
| A6= | −7.5294785E−04 | −2.1660881E−03 | −4.6498305E−04 | 2.7345828E−04 |
| A8= | 9.3983317E−05 | 7.0251177E−04 | 7.1558790E−05 | 3.0439467E−05 |
| A10= | −6.6686231E−06 | −2.6823553E−04 | −1.7476097E−05 | 5.1100632E−06 |
| A12= | 2.7968197E−07 | 6.9738067E−05 | 2.9963319E−06 | −2.7343203E−06 |
| A14= | −6.3815979E−09 | −1.0620068E−05 | −9.1333950E−08 | 4.7960881E−07 |
| A16= | 6.3198751E−11 | 8.4870643E−07 | −6.6226905E−09 | −2.4828400E−08 |
| A18= | — | −2.7944655E−08 | — | — |

| Surface # | 12 | 13 | 14 | 15 |
|---|---|---|---|---|
| k= | 0.00000E+00 | 0.00000E+00 | 0.00000E+00 | −1.00000E+00 |
| A4= | −1.2940409E−02 | 2.0540296E−02 | 2.2667600E−02 | −2.2183379E−02 |
| A6= | 6.4749823E−03 | −5.1043994E−02 | −4.1025368E−02 | 8.5661526E−03 |
| A8= | −1.3849841E−02 | 3.4076066E−02 | 3.0529899E−02 | −9.3676244E−04 |
| A10= | 1.4594774E−02 | −1.2398640E−02 | −1.3460030E−02 | −1.4934155E−03 |
| A12= | −9.1771609E−03 | 2.6996474E−03 | 4.2654673E−03 | 1.1645533E−03 |
| A14= | 3.3615839E−03 | −3.5987726E−04 | −1.0076150E−03 | −4.2389367E−04 |
| A16= | −6.6057515E−04 | 2.3955576E−05 | 1.4873136E−04 | 8.4652576E−05 |
| A18= | 5.3755789E−05 | — | −9.4741082E−06 | −8.8653707E−06 |
| A20= | — | — | — | 3.8072439E−07 |
| Surface # | 16 | 17 | 18 | 19 |
| k= | 0.00000E+00 | 0.00000E+00 | 0.00000E+00 | 0.00000E+00 |
| A4= | −2.1297478E−02 | −3.3772422E−02 | −4.5909364E−02 | −1.7299106E−02 |
| A6= | 6.9048833E−03 | 1.4877917E−02 | 1.1496550E−02 | 4.4607086E−04 |
| A8= | −1.4164403E−03 | −5.6542982E−03 | −3.7975603E−03 | 4.1770715E−06 |
| A10= | −1.0992330E−04 | 1.6625889E−03 | 9.4450207E−04 | −2.2699474E−06 |
| A12= | 1.8525333E−04 | −3.4269260E−04 | −1.6329289E−04 | 6.5462669E−08 |
| A14= | −5.4844084E−05 | 4.5079006E−05 | 1.7698632E−05 | −7.1060620E−08 |
| A16= | 7.1355563E−06 | −3.3499277E−06 | −1.0797819E−06 | 9.6201785E−09 |
| A18= | −3.5389049E−07 | 1.0668215E−07 | 2.7752915E−08 | −3.9501606E−10 |

In the 3rd embodiment, the equation of the aspheric surface profiles of the aforementioned lens elements is the same as the equation of the 1st embodiment. Also, the definitions of these parameters shown in Table 3D are the same as those stated in the 1st embodiment with corresponding values for the 3rd embodiment, so an explanation in this regard will not be provided again.

Moreover, these parameters can be calculated from Table 3A, Table 3B and Table 3C as the following values and satisfy the following conditions:

TABLE 3D
Schematic Parameters

| | | | |
|---|---|---|---|
| fd [mm] | 2.58 | (R9 − R16)/(R9 + R16) | 0.29 |
| Fnod | 1.75 | (R11 + R12)/(R11 − R12) | 0.45 |
| HFOVd [deg.] | 80.0 | \|R12 − R13\|/T67 | 4.84 |
| TLd/fd | 7.72 | CT1/T23 | 0.66 |
| TLd/ImgH | 5.47 | CT1/CT7 | 0.51 |
| TD/BLd | 9.57 | T12/T23 | 0.60 |
| Σ\|fd/fid\| | 2.87 | T23/CT3 | 0.81 |
| \|f1d/R1\| | 0.72 | N8d | 1.544 |
| \|f2d/f6d\| | 2.15 | V2/V3 | 2.87 |
| \|fd/R15\| + \|fd/R16\| | 1.54 | Y1R1d/Y5R1d | 4.01 |
| fd/CT8 | 1.61 | Y1R1d/ImgH | 1.86 |
| \|R11/fd\| | 3.16 | Sag2R1d/CT2 | 1.08 |
| (R5 + R6)/(R5 − R6) | 1.17 | — | — |

### 4th Embodiment

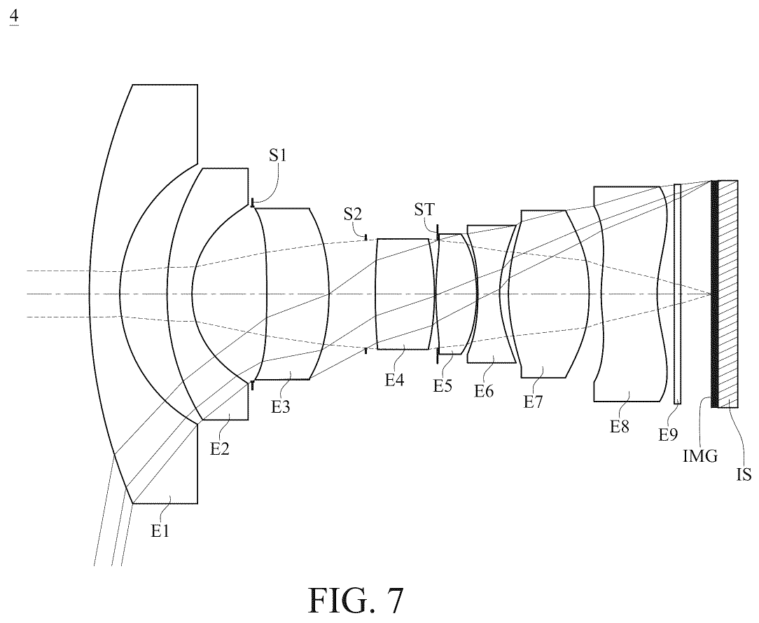

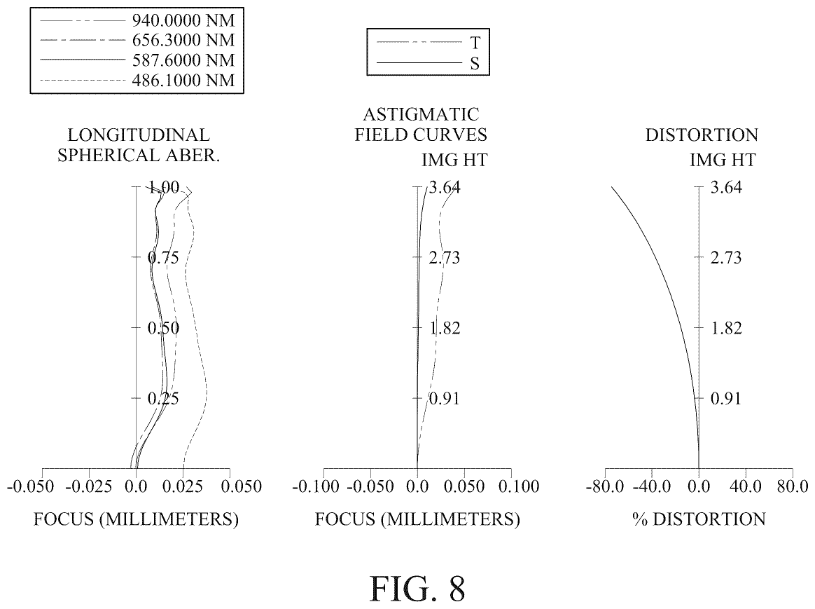

FIG. 7 is a schematic view of an image capturing unit according to the 4th embodiment of the present disclosure. FIG. 8 shows, in order from left to right, spherical aberration curves, astigmatic field curves and a distortion curve of the image capturing unit according to the 4th embodiment. In FIG. 7, the image capturing unit 4 includes the photographing optical lens assembly (its reference numeral is omitted) of the present disclosure and an image sensor IS. The photographing optical lens assembly includes, in order from an object side to an image side along an optical axis, a first lens element E1, a second lens element E2, a stop S1, a third lens element E3, a stop S2, a fourth lens element E4, an aperture stop ST, a fifth lens element E5, a sixth lens element E6, a seventh lens element E7, an eighth lens element E8, a filter E9 and an image surface IMG. The photographing optical lens assembly includes eight lens elements (E1, E2, E3, E4, E5, E6, E7 and E8) with no additional lens element disposed between each of the adjacent eight lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The image-side surface of the second lens element E2 has one inflection point.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric.

The fourth lens element E4 with positive refractive power has an object-side surface being convex in a paraxial region thereof and an image-side surface being convex in a paraxial region thereof. The fourth lens element E4 is made of glass material and has the object-side surface and the image-side surface being both spherical.

The fifth lens element E5 with positive refractive power has an object-side surface being convex in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The object-side surface of the fifth lens element E5 has one critical point in an off-axis region thereof.

The sixth lens element E6 with negative refractive power has an object-side surface being concave in a paraxial region thereof and an image-side surface being concave in a paraxial region thereof. The sixth lens element E6 is made of plastic material and has the object-side surface and the image-side surface being both aspheric.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The image-side surface of the seventh lens element E7 has one inflection point.

The eighth lens element E8 with negative refractive power has an object-side surface being convex in a paraxial region thereof and an image-side surface being concave in a paraxial region thereof. The eighth lens element E8 is made of plastic material and has the object-side surface and the image-side surface being both aspheric. The object-side surface of the eighth lens element E8 has one inflection point. The image-side surface of the eighth lens element E8 has one inflection point. The object-side surface of the eighth lens element E8 has one critical point in an off-axis region thereof. The image-side surface of the eighth lens element E8 has one critical point in an off-axis region thereof.

The filter E9 is made of plastic material and located between the eighth lens element E8 and the image surface IMG, and will not affect the focal length of the photographing optical lens assembly. The image sensor IS is disposed on or near the image surface IMG of the photographing optical lens assembly.

Among the first lens element E1 to the eighth lens element E8, there is one lens element served as a positive lens element with an Abbe number smaller than 30.0, which is the third lens element E3.

The detailed optical data of the 4th embodiment are shown in Table 4A to Table 4B and the aspheric surface data are shown in Table 4C below.

TABLE 4A
4th Embodiment
f = 2.59 mm, Fno = 1.75, HFOV = 79.7 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | 16.9148 | (SPH) | 0.978 | Glass | 1.816 | 42.7 | −8.39 |
| 2 | | 4.7487 | (SPH) | 1.521 | | | | |
| 3 | Lens 2 | 9.2133 | (ASP) | 0.800 | Plastic | 1.535 | 56.0 | −9.52 |
| 4 | | 3.1816 | (ASP) | 1.943 | | | | |
| 5 | Stop | Plano | | 0.460 | | | | |
| 6 | Lens 3 | −46.2259 | (ASP) | 2.000 | Plastic | 1.641 | 19.5 | 14.28 |
| 7 | | −7.7715 | (ASP) | 1.184 | | | | |
| 8 | Stop | Plano | | 0.302 | | | | |
| 9 | Lens 4 | 20.9624 | (SPH) | 1.901 | Glass | 1.787 | 46.6 | 7.57 |
| 10 | | −8.0000 | (SPH) | 0.099 | | | | |
| 11 | Ape. Stop | Plano | | −0.049 | | | | |
| 12 | Lens 5 | 9.0367 | (ASP) | 1.307 | Plastic | 1.536 | 56.1 | 6.12 |
| 13 | | −4.8935 | (ASP) | 0.040 | | | | |
| 14 | Lens 6 | −8.2966 | (ASP) | 0.700 | Plastic | 1.641 | 19.5 | −3.59 |
| 15 | | 3.2951 | (ASP) | 0.283 | | | | |
| 16 | Lens 7 | 4.7899 | (ASP) | 2.592 | Plastic | 1.536 | 56.1 | 6.09 |
| 17 | | −8.3419 | (ASP) | 0.389 | | | | |
| 18 | Lens 8 | 5.1661 | (ASP) | 1.796 | Plastic | 1.535 | 56.0 | −86.31 |
| 19 | | 4.0833 | (ASP) | 0.550 | | | | |

| | | | | | | | |
|---|---|---|---|---|---|---|---|
| 20 | Filter | Plano | 0.210 | Plastic | 1.508 | 64.2 | — |
| 21 | | Plano | 0.988 | | | | |
| 22 | Image | Plano | — | | | | |

Note:
Reference wavelength is 940.0 nm.
An effective radius of the stop S1 (Surface 5) is 2.810 mm.
An effective radius of the stop S2 (Surface 8) is 1.750 mm.

TABLE 4B
4th Embodiment
Note: Reference wavelength is 587.6 nm (d-line).
fd = 2.58 mm, Fnod = 1.75, HFOVd = 80.0 deg., TLd = 19.995 mm

| Element | Index | Focal Length |
|---|---|---|
| Lens 1 | 1.835 | −8.21 |
| Lens 2 | 1.544 | −9.37 |
| Lens 3 | 1.669 | 13.68 |
| Lens 4 | 1.804 | 7.42 |
| Lens 5 | 1.545 | 6.02 |
| Lens 6 | 1.669 | −3.44 |
| Lens 7 | 1.545 | 6.00 |
| Lens 8 | 1.544 | −86.17 |
| Filter | 1.517 | — |

TABLE 4C
Aspheric Coefficients

| Surface # | 3 | 4 | 6 | 7 |
|---|---|---|---|---|
| k= | 0.00000E+00 | 0.00000E+00 | 0.00000E+00 | 0.00000E+00 |
| A4= | 2.6428691E−03 | 3.4772152E−03 | −3.3200231E−03 | −2.0967989E−03 |
| A6= | −1.9197712E−04 | −2.5842480E−04 | 6.5013544E−05 | −1.6560726E−04 |
| A8= | −1.6882355E−05 | 5.8850157E−05 | −1.5095302E−04 | 4.8693367E−05 |
| A10= | 4.7010838E−06 | −4.0782020E−05 | 4.5088435E−05 | −1.2781826E−05 |
| A12= | −3.7700944E−07 | 9.4581716E−06 | −7.4714452E−06 | 1.8181097E−06 |
| A14= | 1.2975621E−08 | −8.5248644E−07 | 5.5480065E−07 | −1.2427296E−07 |
| A16= | −1.5492011E−10 | 2.0302427E−08 | −1.3543944E−08 | 3.4910806E−09 |
| A18= | — | −1.2257342E−10 | — | — |
| Surface # | 12 | 13 | 14 | 15 |
| k= | 0.00000E+00 | 0.00000E+00 | 0.00000E+00 | −1.00000E+00 |
| A4= | −5.8332763E−03 | 7.5253834E−03 | −7.0367144E−03 | −3.0373633E−02 |
| A6= | 5.0656190E−03 | −1.2601471E−02 | 8.9079684E−05 | 1.9459401E−02 |
| A8= | −9.8983006E−03 | 4.1429878E−03 | −3.3977525E−03 | −1.1040138E−02 |
| A10= | 9.7105338E−03 | −2.3105491E−04 | 2.7745660E−03 | 4.5928783E−03 |
| A12= | −5.6567058E−03 | −2.3026080E−04 | −8.9252703E−04 | −1.3692018E−03 |
| A14= | 1.9080687E−03 | 6.0123893E−05 | 1.1801255E−04 | 2.8533781E−04 |
| A16= | −3.4613893E−04 | −4.7941113E−06 | −2.8580271E−07 | −3.9550725E−05 |
| A18= | 2.6025253E−05 | — | −9.1334818E−07 | 3.2770777E−06 |
| A20= | — | — | — | −1.2252853E−07 |
| Surface # | 16 | 17 | 18 | 19 |
| k= | 0.00000E+00 | 0.00000E+00 | 0.00000E+00 | 0.00000E+00 |
| A4= | −1.9597733E−02 | −3.5711423E−02 | −4.6614948E−02 | −1.8939605E−02 |
| A6= | 9.1720905E−03 | 1.3982342E−02 | 1.1027066E−02 | 8.7294825E−04 |
| A8= | −3.6644223E−03 | −3.9805384E−03 | −2.0809450E−03 | 1.9399266E−04 |
| A10= | 1.1198334E−03 | 8.7761373E−04 | 2.7786462E−04 | −7.4885838E−05 |
| A12= | −2.6093988E−04 | −1.3914783E−04 | −2.3360458E−05 | 1.1646086E−05 |
| A14= | 4.2079296E−05 | 1.4565589E−05 | 7.3043155E−07 | −1.0268217E−06 |
| A16= | −4.0629593E−06 | −9.0606682E−07 | 3.4560324E−08 | 4.8807653E−08 |
| A18= | 1.7527919E−07 | 2.6007708E−08 | −2.2978739E−09 | −9.6735505E−10 |

In the 4th embodiment, the equation of the aspheric surface profiles of the aforementioned lens elements is the same as the equation of the 1st embodiment. Also, the definitions of these parameters shown in Table 4D are the same as those stated in the 1st embodiment with corresponding values for the 4th embodiment, so an explanation in this regard will not be provided again.

Moreover, these parameters can be calculated from Table 4A, Table 4B and Table 4C as the following values and satisfy the following conditions:

TABLE 4D
Schematic Parameters

| | | | |
|---|---|---|---|
| fd [mm] | 2.58 | (R9 − R16)/(R9 + R16) | 0.38 |
| Fnod | 1.75 | (R11 + R12)/(R11 − R12) | 0.43 |
| HFOVd [deg.] | 80.0 | \|R12 − R13\|/T67 | 5.28 |
| TLd/fd | 7.74 | CT1/T23 | 0.41 |
| TLd/ImgH | 5.49 | CT1/CT7 | 0.38 |
| TD/BLd | 10.43 | T12/T23 | 0.63 |
| Σ\|fd/fid\| | 2.77 | T23/CT3 | 1.20 |
| \|f1d/R1\| | 0.49 | N8d | 1.544 |
| \|f2d/f6d\| | 2.72 | V2/V3 | 2.87 |
| \|fd/R15\| + \|fd/R16\| | 1.13 | Y1R1d/Y5R1d | 3.82 |
| fd/CT8 | 1.44 | Y1R1d/ImgH | 1.83 |
| \|R11/fd\| | 3.21 | Sag2R1d/CT2 | 1.41 |
| (R5 + R6)/(R5 − R6) | 1.40 | — | — |

### 5th Embodiment

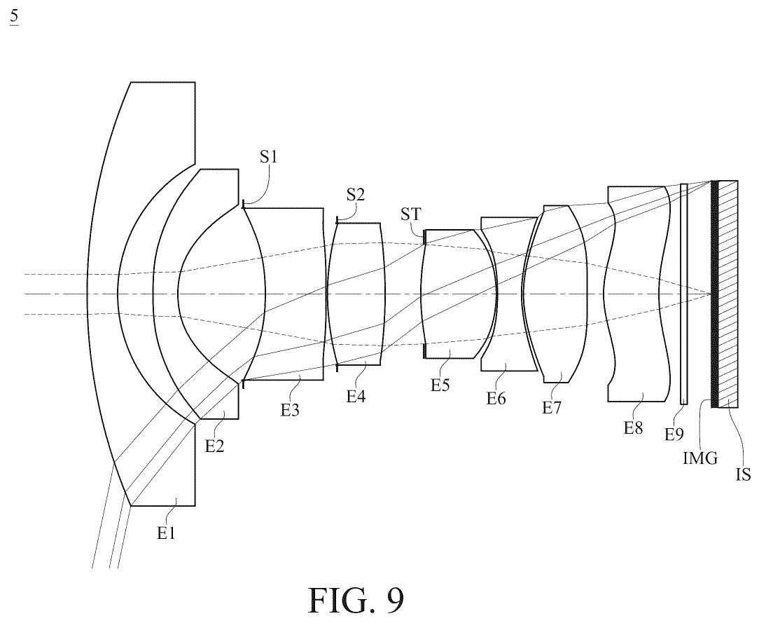

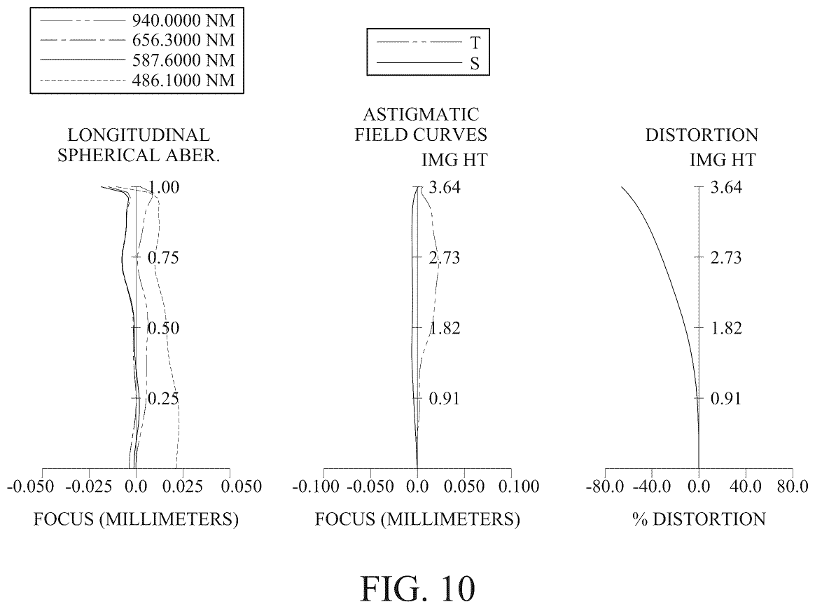

FIG. 9 is a schematic view of an image capturing unit according to the 5th embodiment of the present disclosure. FIG. 10 shows, in order from left to right, spherical aberration curves, astigmatic field curves and a distortion curve of the image capturing unit according to the 5th embodiment. In FIG. 9, the image capturing unit 5 includes the photographing optical lens assembly (its reference numeral is omitted) of the present disclosure and an image sensor IS. The photographing optical lens assembly includes, in order from an object side to an image side along an optical axis, a first lens element E1, a second lens element E2, a stop S1, a third lens element E3, a stop S2, a fourth lens element E4, an aperture stop ST, a fifth lens element E5, a sixth lens element E6, a seventh lens element E7, an eighth lens element E8, a filter E9 and an image surface IMG. The photographing optical lens assembly includes eight lens elements (E1, E2, E3, E4, E5, E6, E7 and E8) with no additional lens element disposed between each of the adjacent eight lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point.

The third lens element E3 with negative refractive power has an object-side surface being concave in a paraxial region thereof and an image-side surface being concave in a paraxial region thereof. The third lens element E3 is made of plastic material and has the object-side surface and the image-side surface being both aspheric. The image-side surface of the third lens element E3 has two inflection points. The image-side surface of the third lens element E3 has two critical points in an off-axis region thereof.

The fourth lens element E4 with positive refractive power has an object-side surface being convex in a paraxial region thereof and an image-side surface being convex in a paraxial region thereof. The fourth lens element E4 is made of glass material and has the object-side surface and the image-side surface being both aspheric.

The fifth lens element E5 with positive refractive power has an object-side surface being convex in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point.

The sixth lens element E6 with negative refractive power has an object-side surface being concave in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The image-side surface of the seventh lens element E7 has two inflection points. The image-side surface of the seventh lens element E7 has one critical point in an off-axis region thereof.

The eighth lens element E8 with positive refractive power has an object-side surface being convex in a paraxial region thereof and an image-side surface being concave in a paraxial region thereof. The eighth lens element E8 is made of plastic material and has the object-side surface and the image-side surface being both aspheric. The object-side surface of the eighth lens element E8 has one inflection point. The image-side surface of the eighth lens element E8 has one inflection point. The object-side surface of the eighth lens element E8 has one critical point in an off-axis region thereof. The image-side surface of the eighth lens element E8 has one critical point in an off-axis region thereof.

The filter E9 is made of glass material and located between the eighth lens element E8 and the image surface IMG, and will not affect the focal length of the photographing optical lens assembly. The image sensor IS is disposed on or near the image surface IMG of the photographing optical lens assembly.

The detailed optical data of the 5th embodiment are shown in Table 5A to Table 5B and the aspheric surface data are shown in Table 5C below.

TABLE 5A
5th Embodiment
f = 2.24 mm, Fno = 1.75, HFOV = 78.2 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | 17.1637 | (SPH) | 0.982 | Glass | 1.716 | 54.7 | −9.49 |
| 2 | | 4.7520 | (SPH) | 1.136 | | | | |
| 3 | Lens 2 | 12.8898 | (ASP) | 0.800 | Plastic | 1.535 | 56.0 | −7.93 |
| 4 | | 3.1247 | (ASP) | 2.100 | | | | |
| 5 | Stop | Plano | | 0.711 | | | | |
| 6 | Lens 3 | −6.9832 | (ASP) | 1.946 | Plastic | 1.553 | 37.4 | −11.37 |
| 7 | | 69.1966 | (ASP) | 0.358 | | | | |
| 8 | Stop | Plano | | −0.308 | | | | |
| 9 | Lens 4 | 6.8116 | (ASP) | 1.854 | Glass | 1.887 | 35.2 | 5.28 |
| 10 | | −13.0460 | (ASP) | 1.245 | | | | |
| 11 | Ape. Stop | Plano | | −0.099 | | | | |
| 12 | Lens 5 | 7.8762 | (ASP) | 2.425 | Plastic | 1.535 | 56.0 | 5.08 |
| 13 | | −3.7057 | (ASP) | 0.040 | | | | |
| 14 | Lens 6 | −6.8026 | (ASP) | 0.772 | Plastic | 1.641 | 19.5 | −3.88 |
| 15 | | 4.1046 | (ASP) | 0.062 | | | | |
| 16 | Lens 7 | 3.6698 | (ASP) | 2.046 | Plastic | 1.535 | 56.0 | 7.35 |
| 17 | | 43.8018 | (ASP) | 0.529 | | | | |
| 18 | Lens 8 | 3.1453 | (ASP) | 1.778 | Plastic | 1.535 | 56.0 | 10.36 |
| 19 | | 5.8345 | (ASP) | 0.700 | | | | |

| | | | | | | | |
|---|---|---|---|---|---|---|---|
| 20 | Filter | Plano | 0.210 | Glass | 1.508 | 64.2 | — |
| 21 | | Plano | 0.779 | | | | |
| 22 | Image | Plano | — | | | | |

Note:
Reference wavelength is 940.0 nm.
An effective radius of the stop S1 (Surface 5) is 2.766 mm.
An effective radius of the stop S2 (Surface 8) is 2.278 mm.

TABLE 5B
5th Embodiment
Note: Reference wavelength is 587.6 nm (d-line).
fd = 2.24 mm, Fnod = 1.75, HFOVd = 78.4 deg., TLd = 20.065 mm

| Element | Index | Focal Length |
|---|---|---|
| Lens 1 | 1.729 | −9.32 |
| Lens 2 | 1.544 | −7.81 |
| Lens 3 | 1.566 | −11.10 |
| Lens 4 | 1.911 | 5.14 |
| Lens 5 | 1.544 | 5.00 |
| Lens 6 | 1.669 | −3.72 |
| Lens 7 | 1.544 | 7.23 |
| Lens 8 | 1.544 | 10.17 |
| Filter | 1.517 | — |

TABLE 5C
Aspheric Coefficients

| Surface # | 3 | 4 | 6 | 7 |
|---|---|---|---|---|
| k= | 0.00000E+00 | 0.00000E+00 | 0.00000E+00 | 0.00000E+00 |
| A4= | 1.8276473E−02 | 1.9978746E−02 | −5.4160059E−03 | −2.0891467E−02 |
| A6= | −3.7337655E−03 | −2.4742974E−03 | −4.5202036E−04 | 6.3968577E−03 |
| A8= | 4.9165991E−04 | −1.3612903E−03 | 3.6191952E−04 | −1.3125837E−03 |
| A10= | −4.2775543E−05 | 6.8862077E−04 | −5.8897202E−05 | 2.2991680E−04 |
| A12= | 2.4551595E−06 | −1.5603625E−04 | 4.5766361E−06 | −3.0434710E−05 |
| A14= | −8.2778914E−08 | 1.9916885E−05 | −1.5585847E−07 | 2.8322313E−06 |
| A16= | 1.2006387E−09 | −1.3520714E−06 | 8.4345759E−10 | −1.2105777E−07 |
| A18= | — | 3.6478303E−08 | — | — |

| Surface # | 9 | 10 | 12 | 13 |
|---|---|---|---|---|
| k= | −9.28708E+00 | −1.30558E+01 | 0.00000E+00 | 0.00000E+00 |
| A4= | −5.1048759E−03 | 3.5701150E−03 | 8.0336672E−04 | 1.2490887E−02 |
| A6= | 2.8398749E−03 | −1.0738459E−03 | 4.5746472E−03 | −2.5890970E−02 |
| A8= | −6.4649302E−04 | 8.2295694E−05 | −1.2165497E−02 | 2.0013714E−02 |
| A10= | 7.8813943E−05 | 1.3975918E−06 | 1.4183194E−02 | −9.2310447E−03 |
| A12= | −3.7407822E−06 | −4.4776060E−07 | −9.6955777E−03 | 2.4511384E−03 |
| A14= | — | — | 3.8399468E−03 | −3.4790545E−04 |
| A16= | — | — | −8.1709983E−04 | 2.0631441E−05 |
| A18= | — | — | 7.2147882E−05 | — |

| Surface # | 14 | 15 | 16 | 17 |
|---|---|---|---|---|
| k= | 0.00000E+00 | −1.00000E+00 | 0.00000E+00 | 0.00000E+00 |
| A4= | 1.4627229E−03 | −2.3954693E−02 | −2.8926637E−02 | −2.7310197E−02 |
| A6= | −2.2827308E−02 | 1.0546309E−02 | 1.3946362E−02 | 6.1877292E−03 |
| A8= | 1.9407125E−02 | −3.0701546E−03 | −6.0085638E−03 | −1.0815758E−03 |
| A10= | −9.6804667E−03 | 2.8549934E−04 | 1.7361056E−03 | 8.1874056E−05 |
| A12= | 2.9192421E−03 | 1.6795394E−04 | −3.2049359E−04 | 4.0743686E−07 |
| A14= | −5.3464463E−04 | −7.7473652E−05 | 3.5571265E−05 | 1.7910097E−07 |
| A16= | 5.6022434E−05 | 1.4492070E−05 | −2.1325896E−06 | −1.0166486E−07 |
| A18= | −2.5606214E−06 | −1.3057371E−06 | 5.2345472E−08 | 6.3994101E−09 |
| A20= | — | 4.6216816E−08 | — | — |

| Surface # | 18 | 19 |
|---|---|---|
| k= | 0.00000E+00 | 0.00000E+00 |
| A4= | −2.8150667E−02 | 5.4872042E−03 |
| A6= | 2.8404225E−03 | −5.9675594E−03 |
| A8= | −7.2379990E−04 | 1.5022074E−03 |
| A10= | 1.9953599E−04 | −2.2531153E−04 |
| A12= | −4.6414655E−05 | 2.0858502E−05 |
| A14= | 6.2001326E−06 | −1.1505456E−06 |
| A16= | −4.2632373E−07 | 3.2843971E−08 |
| A18= | 1.1423917E−08 | −3.3182557E−10 |

In the 5th embodiment, the equation of the aspheric surface profiles of the aforementioned lens elements is the same as the equation of the 1st embodiment. Also, the definitions of these parameters shown in Table 5D are the same as those stated in the 1st embodiment with corresponding values for the 5th embodiment, so an explanation in this regard will not be provided again.

Moreover, these parameters can be calculated from Table 5A, Table 5B and Table 5C as the following values and satisfy the following conditions:

TABLE 5D
Schematic Parameters

| | | | |
|---|---|---|---|
| fd [mm] | 2.24 | (R9 − R16)/(R9 + R16) | 0.15 |
| Fnod | 1.75 | (R11 + R12)/(R11 − R12) | 0.25 |
| HFOVd [deg.] | 78.4 | \|R12 − R13\|/T67 | 7.01 |
| TLd/fd | 8.97 | CT1/T23 | 0.35 |
| TLd/ImgH | 5.51 | CT1/CT7 | 0.48 |
| TD/BLd | 10.88 | T12/T23 | 0.40 |
| Σ\|fd/fid\| | 2.74 | T23/CT3 | 1.44 |
| \|f1d/R1\| | 0.54 | N8d | 1.544 |
| \|f2d/f6d\| | 2.10 | V2/V3 | 1.50 |
| \|fd/R15\| + \|fd/R16\| | 1.09 | Y1R1d/Y5R1d | 4.15 |
| fd/CT8 | 1.26 | Y1R1d/ImgH | 1.86 |
| \|R11/fd\| | 3.04 | Sag2R1d/CT2 | 1.90 |
| (R5 + R6)/(R5 − R6) | −0.82 | — | — |

### 6th Embodiment

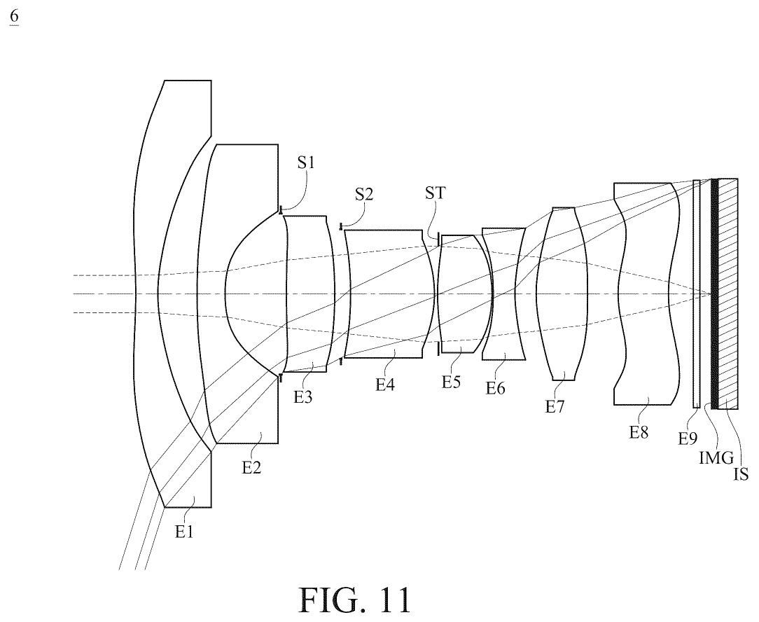

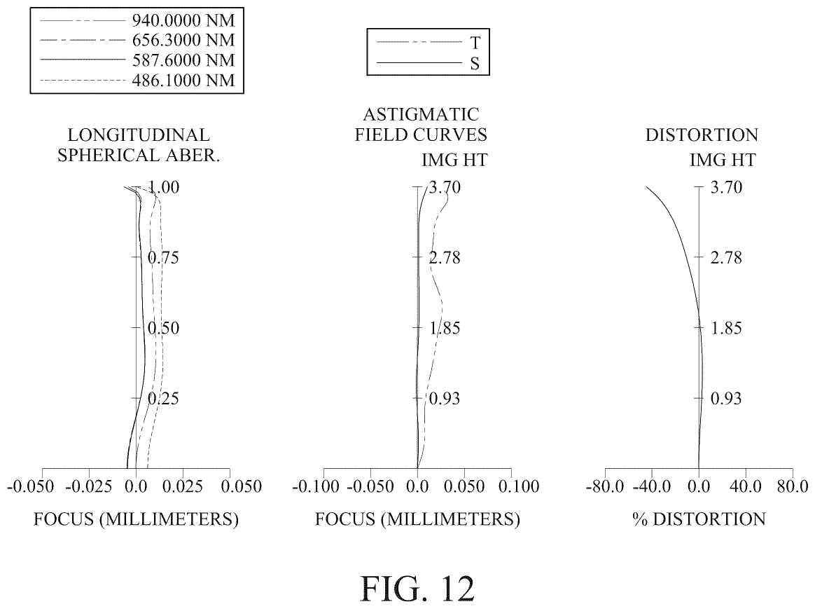

FIG. 11 is a schematic view of an image capturing unit according to the 6th embodiment of the present disclosure. FIG. 12 shows, in order from left to right, spherical aberration curves, astigmatic field curves and a distortion curve of the image capturing unit according to the 6th embodiment. In FIG. 11, the image capturing unit 6 includes the photographing optical lens assembly (its reference numeral is omitted) of the present disclosure and an image sensor IS. The photographing optical lens assembly includes, in order from an object side to an image side along an optical axis, a first lens element E1, a 10 second lens element E2, a stop S1, a third lens element E3, a stop S2, a fourth lens element E4, an aperture stop ST, a fifth lens element E5, a sixth lens element E6, a seventh lens element E7, an eighth lens element E8, a filter E9 and an image surface IMG. The photographing optical lens assembly includes eight lens elements (E1, E2, E3, E4, E5, E6, E7 and E8) with no additional lens element disposed between each of the adjacent eight lens elements.

The first lens element E1 with negative refractive power has an object-side surface being concave in a paraxial region thereof and an image-side surface being concave in a paraxial region thereof. The first lens element E1 is made of plastic material and has the object-side surface and the image-side surface being both aspheric. The object-side surface of the first lens element E1 has two inflection points. The image-side surface of the first lens element E1 has one inflection point. The object-side surface of the first lens element E1 has one critical point in an off-axis region thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points. The image-side surface of the second lens element E2 has one inflection point.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has one inflection point. The object-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point.

The fifth lens element E5 with positive refractive power has an object-side surface being convex in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point.

The sixth lens element E6 with negative refractive power has an object-side surface being concave in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The image-side surface of the seventh lens element E7 has one inflection point.

The eighth lens element E8 with positive refractive power has an object-side surface being convex in a paraxial region thereof and an image-side surface being concave in a paraxial region thereof. The eighth lens element E8 is made of plastic material and has the object-side surface and the image-side surface being both aspheric. The object-side surface of the eighth lens element E8 has two inflection points. The image-side surface of the eighth lens element E8 has two inflection points. The object-side surface of the eighth lens element E8 has one critical point in an off-axis region thereof. The image-side surface of the eighth lens element E8 has one critical point in an off-axis region thereof.

The filter E9 is made of glass material and located between the eighth lens element E8 and the image surface IMG, and will not affect the focal length of the photographing optical lens assembly. The image sensor IS is disposed on or near the image surface IMG of the photographing optical lens assembly.

Among the first lens element E1 to the eighth lens element E8, there is one lens element served as a positive lens element with an Abbe number smaller than 30.0, which is the third lens element E3.

The detailed optical data of the 6th embodiment are shown in Table 6A to Table 6B and the aspheric surface data are shown in Table 6C below.

TABLE 6A
6th Embodiment
f = 2.11 mm, Fno = 1.75, HFOV = 72.5 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | −17.0837 | (ASP) | 0.711 | Plastic | 1.535 | 56.0 | −7.41 |
| 2 | | 5.2388 | (ASP) | 1.263 | | | | |
| 3 | Lens 2 | 30.3093 | (ASP) | 0.898 | Plastic | 1.535 | 56.0 | −9.86 |
| 4 | | 4.4493 | (ASP) | 1.787 | | | | |
| 5 | Stop | Plano | | 0.186 | | | | |
| 6 | Lens 3 | 82.7641 | (ASP) | 1.550 | Plastic | 1.657 | 18.4 | 16.30 |
| 7 | | −12.2051 | (ASP) | 0.198 | | | | |
| 8 | Stop | Plano | | 0.311 | | | | |
| 9 | Lens 4 | −11.6291 | (ASP) | 2.694 | Plastic | 1.535 | 56.0 | 10.01 |
| 10 | | −3.9647 | (ASP) | 0.132 | | | | |
| 11 | Ape. Stop | Plano | | −0.029 | | | | |
| 12 | Lens 5 | 7.4769 | (ASP) | 1.747 | Plastic | 1.535 | 56.0 | 5.18 |
| 13 | | −4.0420 | (ASP) | 0.040 | | | | |
| 14 | Lens 6 | −7.8630 | (ASP) | 0.700 | Plastic | 1.634 | 20.4 | −4.44 |
| 15 | | 4.5319 | (ASP) | 0.682 | | | | |
| 16 | Lens 7 | 4.5172 | (ASP) | 1.650 | Plastic | 1.535 | 56.0 | 7.93 |
| 17 | | −61.4976 | (ASP) | 0.981 | | | | |
| 18 | Lens 8 | 3.3360 | (ASP) | 1.620 | Plastic | 1.535 | 56.0 | 14.98 |
| 19 | | 4.7455 | (ASP) | 0.800 | | | | |

| | | | | | | | |
|---|---|---|---|---|---|---|---|
| 20 | Filter | Plano | 0.210 | Glass | 1.508 | 64.2 | — |
| 21 | | Plano | 0.372 | | | | |
| 22 | Image | Plano | — | | | | |

Note:
Reference wavelength is 940.0 nm.
An effective radius of the stop S1 (Surface 5) is 2.586 mm.
An effective radius of the stop S2 (Surface 8) is 2.081 mm.

TABLE 6B
6th Embodiment
Note: Reference wavelength is 587.6 nm (d-line).
fd = 2.09 mm, Fnod = 1.75, HFOVd = 72.8 deg., TLd = 18.498 mm

| Element | Index | Focal Length |
|---|---|---|
| Lens 1 | 1.544 | −7.29 |
| Lens 2 | 1.544 | −9.70 |
| Lens 3 | 1.686 | 15.61 |
| Lens 4 | 1.544 | 9.84 |
| Lens 5 | 1.544 | 5.09 |
| Lens 6 | 1.660 | −4.26 |
| Lens 7 | 1.544 | 7.80 |
| Lens 8 | 1.544 | 14.69 |
| Filter | 1.517 | — |

TABLE 6C
Aspheric Coefficients

| Surface # | 1 | 2 | 3 | 4 |
|---|---|---|---|---|
| k= | −9.90000E+01 | −5.40636E−01 | 0.00000E+00 | 0.00000E+00 |
| A4= | 1.9997604E−03 | −9.8622412E−03 | 3.3274698E−03 | 3.2312418E−02 |
| A6= | −3.9773432E−05 | 1.3075572E−03 | −1.6176647E−04 | −4.7068804E−03 |
| A8= | −1.1435818E−06 | −9.6637372E−05 | −5.2917257E−05 | 2.8583194E−03 |
| A10= | 6.7628798E−08 | 3.4710635E−06 | 7.7882218E−06 | −1.6895032E−03 |
| A12= | −7.9915224E−10 | −3.9321811E−08 | −4.5601679E−07 | 5.8235823E−04 |
| A14= | −5.0148910E−12 | −6.3018466E−10 | 1.3329943E−08 | −1.2289119E−04 |
| A16= | 1.0095957E−13 | 1.2998942E−11 | −1.7916522E−10 | 1.5560892E−05 |
| A18= | — | — | 7.1199520E−13 | −1.0720504E−06 |
| A20= | — | — | — | 3.0495765E−08 |

| Surface # | 6 | 7 | 9 | 10 |
|---|---|---|---|---|
| k= | 0.00000E+00 | 0.00000E+00 | 1.99455E+01 | −5.59634E−01 |
| A4= | 7.0355558E−03 | 3.8227484E−03 | 3.2055694E−04 | −8.1645153E−03 |
| A6= | −2.8194978E−03 | −1.9456627E−03 | −8.0756085E−04 | 9.1201365E−03 |
| A8= | 7.2810709E−04 | 1.4700604E−04 | 2.2164228E−04 | −4.8410264E−03 |
| A10= | −2.2580380E−04 | 9.1986535E−06 | 1.1074813E−05 | 1.6604726E−03 |
| A12= | 4.0753253E−05 | −2.5280285E−06 | 1.3598958E−06 | −3.1178518E−04 |
| A14= | −4.0755833E−06 | 4.3692664E−07 | −3.2435440E−07 | 2.4541053E−05 |
| A16= | 1.7471257E−07 | −2.9975665E−08 | — | — |

| Surface # | 12 | 13 | 14 | 15 |
|---|---|---|---|---|
| k= | 0.00000E+00 | 0.00000E+00 | 0.00000E+00 | −1.00000E+00 |
| A4= | −1.2225159E−02 | −5.2546705E−04 | −1.4664973E−02 | −2.9674177E−02 |
| A6= | 9.8490022E−03 | −1.2939440E−02 | 1.2774869E−03 | 1.8402327E−02 |
| A8= | −6.5627967E−03 | 8.0814343E−03 | −2.1632435E−03 | −1.1412998E−02 |
| A10= | 2.7803371E−03 | −2.4161074E−03 | 2.8750845E−03 | 5.6269340E−03 |
| A12= | −8.8791123E−04 | 2.2548148E−04 | −1.4091967E−03 | −1.9602106E−03 |
| A14= | 2.4539769E−04 | 2.9625962E−05 | 2.8633788E−04 | 4.6829070E−04 |
| A16= | −6.0870897E−05 | −5.1975432E−06 | −1.4894950E−05 | −7.4895531E−05 |
| A18= | 7.5113266E−06 | — | −1.1811884E−06 | 7.4369476E−06 |
| A20= | — | — | — | −3.4814331E−07 |

| Surface # | 16 | 17 | 18 | 19 |
|---|---|---|---|---|
| k= | 0.00000E+00 | 0.00000E+00 | 0.00000E+00 | 0.00000E+00 |
| A4= | −1.8925323E−02 | −2.1818059E−02 | −2.8763216E−02 | 6.6653924E−04 |
| A6= | 6.6837423E−03 | 5.4696606E−03 | 4.5468768E−04 | −8.7501501E−03 |
| A8= | −2.2602696E−03 | −5.5416876E−04 | 2.3906343E−04 | 3.4878423E−03 |
| A10= | 4.7188091E−04 | −1.9259373E−04 | 1.2132962E−05 | −8.0515363E−04 |
| A12= | −5.4576118E−05 | 7.7661311E−05 | −3.3179287E−05 | 1.1559560E−04 |
| A14= | 2.4754174E−06 | −1.2135960E−05 | 7.4615588E−06 | −1.0435610E−05 |
| A16= | 1.1649415E−07 | 9.5606151E−07 | −7.1743038E−07 | 5.7577244E−07 |
| A18= | −1.2278125E−08 | −3.0759693E−08 | 3.2251755E−08 | −1.7817561E−08 |
| A20= | — | -— | −5.5648803E−10 | 2.3906414E−10 |

In the 6th embodiment, the equation of the aspheric surface profiles of the aforementioned lens elements is the same as the equation of the 1st embodiment. Also, the definitions of these parameters shown in Table 6D are the same as those stated in the 1st embodiment with corresponding values for the 6th embodiment, so an explanation in this regard will not be provided again.

Moreover, these parameters can be calculated from Table 6A, Table 6B and Table 6C as the following values and satisfy the following conditions:

TABLE 6D
Schematic Parameters

| | | | |
|---|---|---|---|
| fd [mm] | 2.09 | (R9 − R16)/(R9 + R16) | 0.22 |
| Fnod | 1.75 | (R11 + R12)/(R11 − R12) | 0.27 |
| HFOVd [deg.] | 72.8 | \|R12 − R13\|/T67 | 0.02 |
| TLd/fd | 8.84 | CT1/T23 | 0.36 |
| TLd/ImgH | 5.00 | CT1/CT7 | 0.43 |
| TD/BLd | 12.43 | T12/T23 | 0.64 |
| Σ\|fd/fid\| | 2.16 | T23/CT3 | 1.27 |
| \|f1d/R1\| | 0.43 | N8d | 1.544 |
| \|f2d/f6d\| | 2.28 | V2/V3 | 3.04 |
| \|fd/R15\| + \|fd/R16\| | 1.07 | Y1R1d/Y5R1d | 4.33 |
| fd/CT8 | 1.29 | Y1R1d/ImgH | 1.85 |
| \|R11/fd\| | 3.76 | Sag2R1d/CT2 | 0.69 |
| (R5 + R6)/(R5 − R6) | 0.74 | — | — |

### 7th Embodiment

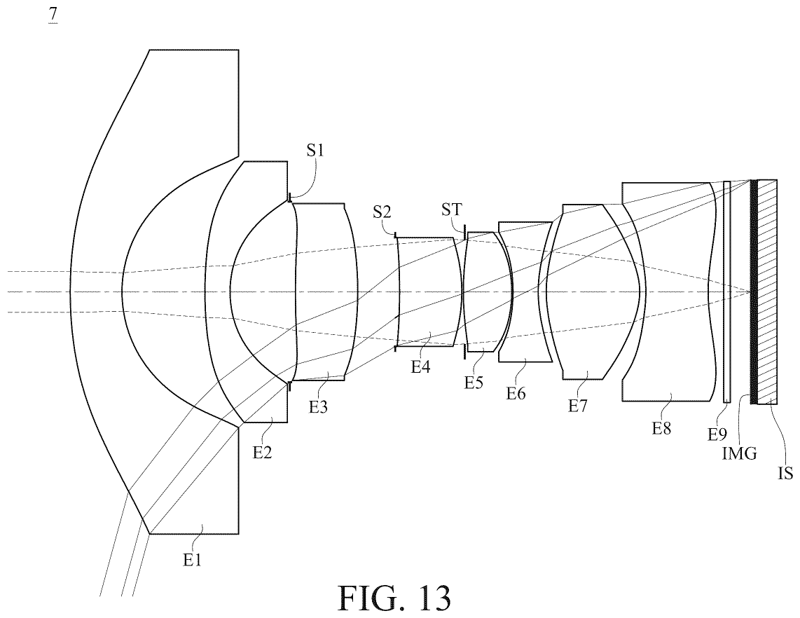

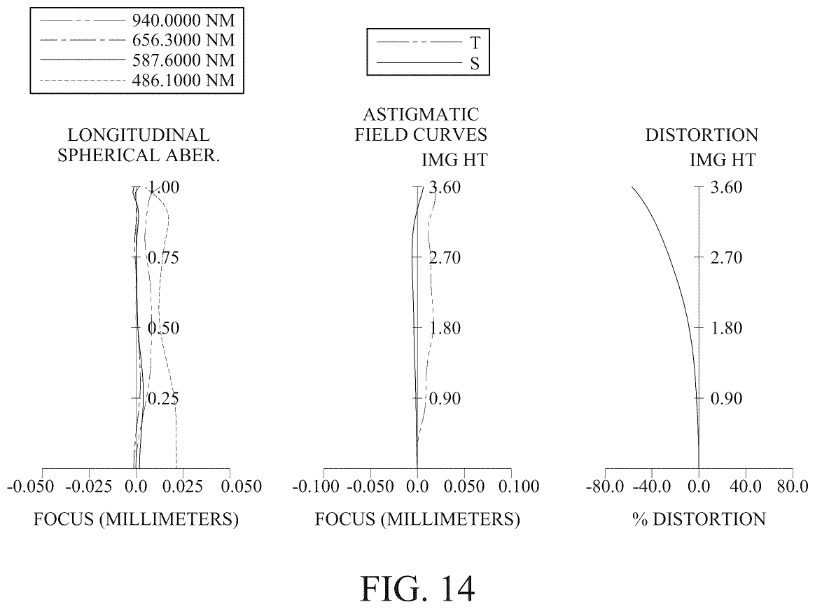

FIG. 13 is a schematic view of an image capturing unit according to the 7th embodiment of the present disclosure. FIG. 14 shows, in order from left to right, spherical aberration curves, astigmatic field curves and a distortion curve of the image capturing unit according to the 7th embodiment. In FIG. 13, the image capturing unit 7 includes the photographing optical lens assembly (its reference numeral is omitted) of the present disclosure and an image sensor IS. The photographing optical lens assembly includes, in order from an object side to an image side along an optical axis, a first lens element E1, a second lens element E2, a stop S1, a third lens element E3, a stop S2, a fourth lens element E4, an aperture stop ST, a fifth lens element E5, a sixth lens element E6, a seventh lens element E7, an eighth lens element E8, a filter E9 and an image surface IMG. The photographing optical lens assembly includes eight lens elements (E1, E2, E3, E4, E5, E6, E7 and E8) with no additional lens element disposed between each of the adjacent eight lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both aspheric. The object-side surface of the first lens element E1 has one inflection point. The image-side surface of the first lens element E1 has one inflection point.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The image-side surface of the second lens element E2 has one inflection point.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has one inflection point. The object-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of glass material and has the object-side surface and the image-side surface being both aspheric. The object-side surface of the fourth lens element E4 has one inflection point. The image-side surface of the fourth lens element E4 has one inflection point.

The fifth lens element E5 with positive refractive power has an object-side surface being convex in a paraxial region thereof and an image-side surface being convex in a paraxial region thereof. The fifth lens element E5 is made of plastic material and has the object-side surface and the image-side surface being both aspheric.

The sixth lens element E6 with negative refractive power has an object-side surface being concave in a paraxial region thereof and an image-side surface being concave in a paraxial region thereof. The sixth lens element E6 is made of plastic material and has the object-side surface and the image-side surface being both aspheric.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The image-side surface of the seventh lens element E7 has one inflection point.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The image-side surface of the eighth lens element E8 has one inflection point. The image-side surface of the eighth lens element E8 has one critical point in an off-axis region thereof.

The filter E9 is made of plastic material and located between the eighth lens element E8 and the image surface IMG, and will not affect the focal length of the photographing optical lens assembly. The image sensor IS is disposed on or near the image surface IMG of the photographing optical lens assembly.

Among the first lens element E1 to the eighth lens element E8, there is one lens element served as a positive lens element with an Abbe number smaller than 30.0, which is the third lens element E3.

The detailed optical data of the 7th embodiment are shown in Table 7A to Table 7B and the aspheric surface data are shown in Table 7C below.

TABLE 7A
7th Embodiment
f = 2.29 mm, Fno = 1.75, HFOV = 74.7 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | 12.8842 | (ASP) | 1.663 | Glass | 1.742 | 47.7 | −8.58 |
| 2 | | 4.0273 | (ASP) | 2.666 | | | | |
| 3 | Lens 2 | 14.6407 | (ASP) | 0.806 | Plastic | 1.535 | 56.0 | −8.56 |
| 4 | | 3.4219 | (ASP) | 1.921 | | | | |
| 5 | Stop | Plano | | 0.179 | | | | |
| 6 | Lens 3 | 27.7979 | (ASP) | 2.000 | Plastic | 1.641 | 19.5 | 12.63 |
| 7 | | −11.1041 | (ASP) | 1.204 | | | | |
| 8 | Stop | Plano | | 0.139 | | | | |
| 9 | Lens 4 | −22.6938 | (ASP) | 2.000 | Glass | 1.758 | 49.5 | 8.66 |
| 10 | | −5.2815 | (ASP) | 0.093 | | | | |
| 11 | Ape. Stop | Plano | | −0.043 | | | | |
| 12 | Lens 5 | 8.5101 | (ASP) | 1.554 | Plastic | 1.535 | 56.0 | 5.21 |
| 13 | | −3.8799 | (ASP) | 0.040 | | | | |
| 14 | Lens 6 | −5.0312 | (ASP) | 0.810 | Plastic | 1.625 | 21.8 | −3.39 |
| 15 | | 3.8907 | (ASP) | 0.260 | | | | |
| 16 | Lens 7 | 4.0683 | (ASP) | 3.000 | Plastic | 1.535 | 56.0 | 3.08 |
| 17 | | −2.0537 | (ASP) | 0.200 | | | | |
| 18 | Lens 8 | −3.9404 | (ASP) | 2.000 | Plastic | 1.540 | 44.8 | −4.06 |
| 19 | | 5.8183 | (ASP) | 0.500 | | | | |

| | | | | | | | |
|---|---|---|---|---|---|---|---|
| 20 | Filter | Plano | 0.210 | Plastic | 1.508 | 64.2 | — |
| 21 | | Plano | 0.656 | | | | |
| 22 | Image | Plano | — | | | | |

Note:
Reference wavelength is 940.0 nm.
An effective radius of the stop S1 (Surface 5) is 2.900 mm.
An effective radius of the stop S2 (Surface 8) is 1.751 mm.

TABLE 7B
7th Embodiment
Note: Reference wavelength is 587.6 nm (d-line).
fd = 2.29 mm, Fnod = 1.75, HFOVd = 75.0 deg., TLd = 21.860 mm

| Element | Index | Focal Length |
|---|---|---|
| Lens 1 | 1.757 | −8.42 |
| Lens 2 | 1.544 | −8.42 |
| Lens 3 | 1.669 | 12.11 |
| Lens 4 | 1.773 | 8.48 |
| Lens 5 | 1.544 | 5.12 |
| Lens 6 | 1.650 | −3.26 |
| Lens 7 | 1.544 | 3.03 |
| Lens 8 | 1.551 | −3.98 |
| Filter | 1.517 | — |

TABLE 7C
Aspheric Coefficients

| Surface # | 1 | 2 | 3 | 4 |
|---|---|---|---|---|
| k= | 5.57696E−02 | −2.09811E−01 | 5.54113E+00 | 1.14708E−01 |
| A4= | 3.1709445E−04 | 2.1401903E−04 | 3.9565800E−03 | 6.7812525E−03 |
| A6= | 1.8778628E−05 | 1.4139661E−04 | −1.0589445E−03 | −1.6463753E−03 |
| A8= | −1.8777160E−06 | −2.2915554E−05 | 2.2172099E−04 | 2.4966373E−04 |
| A10= | 6.0518864E−08 | 3.8866526E−06 | −2.4043160E−05 | −4.8428574E−07 |
| A12= | −1.0294712E−09 | −4.5243721E−07 | 1.4465207E−06 | −3.7604591E−07 |
| A14= | 9.2150349E−12 | 2.8677430E−08 | −4.6258038E−08 | −1.2304211E−06 |
| A16= | −3.4275952E−14 | −7.0633143E−10 | 6.1100136E−10 | 2.1557759E−07 |
| A18= | — | — | — | −1.0761736E−08 |

| Surface # | 6 | 7 | 9 | 10 |
|---|---|---|---|---|
| k= | 8.59276E+01 | −2.56795E+00 | 6.66124E+01 | −7.02888E−01 |
| A4= | −1.7212408E−04 | 1.6759216E−04 | −1.9186199E−04 | −5.8751306E−03 |
| A6= | −7.7240776E−04 | −5.7105296E−04 | −3.5101287E−04 | 6.4203586E−03 |
| A8= | 2.0596575E−04 | 9.5242314E−05 | 1.1624772E−04 | −3.9514014E−03 |
| A10= | −5.8185348E−05 | −2.3477607E−05 | −7.6662745E−06 | 1.6374010E−03 |
| A12= | 8.7493894E−06 | 3.8166894E−06 | 2.1312276E−06 | −3.7254814E−04 |
| A14= | −7.2101659E−07 | −3.3255124E−07 | 1.1539082E−07 | 3.7154461E−05 |
| A16= | 2.2476624E−08 | 1.2649464E−08 | — | — |
| Surface # | 12 | 13 | 14 | 15 |
| k= | 5.94759E+00 | −2.53205E−01 | −1.36867E+00 | −7.75340E−01 |
| A4= | −1.2255221E−02 | 1.4197088E−02 | 3.5281981E−03 | −3.1956160E−02 |
| A6= | 9.0305634E−03 | −1.8650671E−02 | −7.1212404E−03 | 2.0412319E−02 |
| A8= | −5.7586633E−03 | 4.6587227E−03 | −2.9612190E−03 | −1.1590306E−02 |
| A10= | 1.9854779E−03 | 1.3270995E−03 | 4.8569893E−03 | 4.8572510E−03 |
| A12= | −1.0854703E−04 | −1.1052321E−03 | −2.2091513E−03 | −1.4103869E−03 |
| A14= | −1.7059526E−04 | 2.5405055E−04 | 4.7126480E−04 | 2.7260194E−04 |
| A16= | 5.4619142E−05 | −2.0418111E−05 | −4.2940785E−05 | −3.3069775E−05 |
| A18= | −5.2295672E−06 | — | 8.2948140E−07 | 2.2681197E−06 |
| A20= | — | — | — | −6.7440108E−08 |

| Surface # | 16 | 17 | 18 | 19 |
|---|---|---|---|---|
| k= | −5.56317E−01 | −6.50483E+00 | −3.00237E+01 | 6.51511E−01 |
| A4= | −2.4887859E−02 | −1.3457297E−02 | 3.1743101E−03 | −1.3754848E−02 |
| A6= | 1.1463183E−02 | 3.7926445E−03 | −4.4680147E−03 | 2.5885052E−03 |
| A8= | −4.6441278E−03 | −1.1789500E−03 | 1.2354804E−03 | −7.2005956E−04 |
| A10= | 1.3622091E−03 | 3.2183861E−04 | −1.8284739E−04 | 1.3129075E−04 |
| A12= | −2.7463303E−04 | −6.5754885E−05 | 7.2629938E−06 | −1.4519711E−05 |
| A14= | 3.5750768E−05 | 8.3438803E−06 | 1.2121859E−06 | 9.3062730E−07 |
| A16= | −2.6650741E−06 | −5.6760743E−07 | −1.3677100E−07 | −3.2077278E−08 |
| A18= | 8.5651255E−08 | 1.5989545E−08 | 3.8241751E−09 | 4.6191270E−10 |

In the 7th embodiment, the equation of the aspheric surface profiles of the aforementioned lens elements is the same as the equation of the 1st embodiment. Also, the definitions of these parameters shown in Table 7D are the same as those stated in the 1st embodiment with corresponding values for the 7th embodiment, so an explanation in this regard will not be provided again.

Moreover, these parameters can be calculated from Table 7A, Table 7B and Table 7C as the following values and satisfy the following conditions:

TABLE 7D
Schematic Parameters

| | | | |
|---|---|---|---|
| fd [mm] | 2.29 | (R9 − R16)/(R9 + R16) | 0.19 |
| Fnod | 1.75 | (R11 + R12)/(R11 − R12) | 0.13 |
| HFOVd [deg.] | 75.0 | \|R12 − R13\|/T67 | 0.68 |
| TLd/fd | 9.56 | CT1/T23 | 0.79 |
| TLd/ImgH | 6.07 | CT1/CT7 | 0.55 |
| TD/BLd | 14.98 | T12/T23 | 1.27 |
| Σ\|fd/fid\| | 3.48 | T23/CT3 | 1.05 |
| \|f1d/R1\| | 0.65 | N8d | 1.551 |
| \|f2d/f6d\| | 2.58 | V2/V3 | 2.87 |
| \|fd/R15\| + \|fd/R16\| | 0.97 | Y1R1d/Y5R1d | 4.50 |
| fd/CT8 | 1.14 | Y1R1d/ImgH | 2.15 |
| \|R11/fd\| | 2.20 | Sag2R1d/CT2 | 1.53 |
| (R5 + R6)/(R5 − R6) | 0.43 | — | — |

### 8th Embodiment

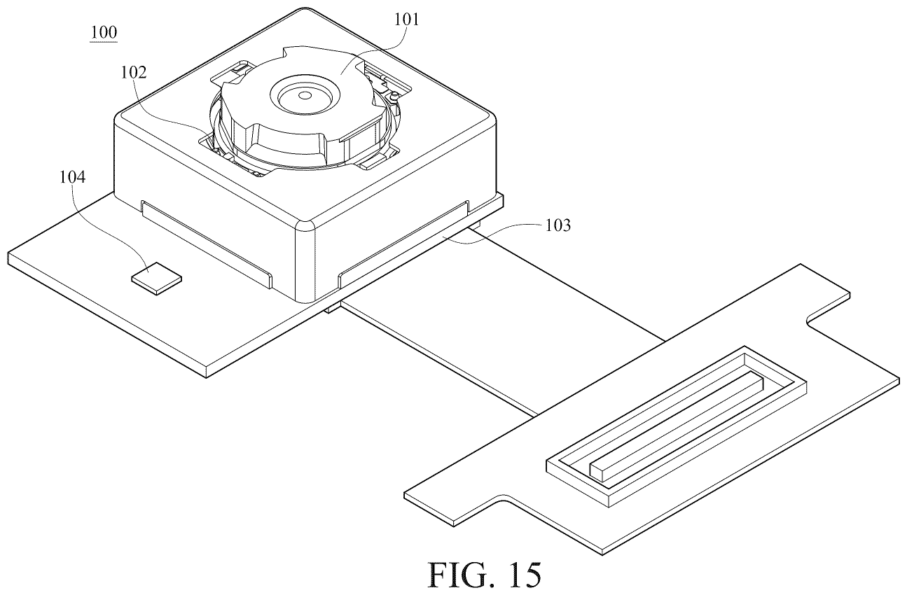

FIG. 15 is a perspective view of an image capturing unit according to the 8th embodiment of the present disclosure. In this embodiment, an image capturing unit 100 is a camera module including a lens unit 101, a driving device 102, an image sensor 103 and an image stabilizer 104. The lens unit 101 includes the photographing optical lens assembly disclosed in the 1st embodiment, a barrel and a holder member (their reference numerals are omitted) for holding the photographing optical lens assembly. However, the lens unit 101 may alternatively be provided with the photographing optical lens assembly disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have auto focusing functionality, and different driving configurations can be obtained through the usages of voice coil motors (VCM), micro electro-mechanical systems (MEMS), piezoelectric systems, or shape memory alloy materials. The driving device 102 is favorable for obtaining a better imaging position of the lens unit 101, so that a clear image of the imaged object can be captured by the lens unit 101 with different object distances. The image sensor 103 (for example, CCD or CMOS), which can feature high photosensitivity and low noise, is disposed on the image surface of the photographing optical lens assembly to provide higher image quality.

The image stabilizer 104, such as an accelerometer, a gyro sensor and a Hall effect sensor, is configured to work with the driving device 102 to provide optical image stabilization (OIS). The driving device 102 working with the image stabilizer 104 is favorable for compensating for pan and tilt of the lens unit 101 to reduce blurring associated with motion during exposure. In some cases, the compensation can be provided by electronic image stabilization (EIS) with image processing software, thereby improving image quality while in motion or low-light conditions.

### 9th Embodiment

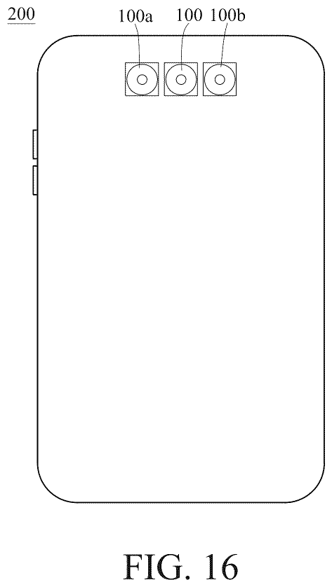

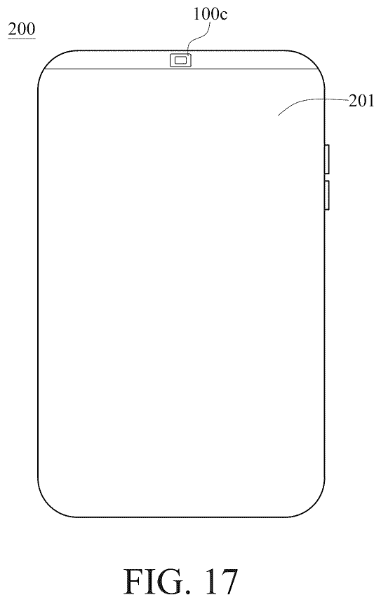

FIG. 16 is one perspective view of an electronic device according to the 9th embodiment of the present disclosure. FIG. 17 is another perspective view of the electronic device in FIG. 16.

In this embodiment, an electronic device 200 is a smartphone including the image capturing unit 100 disclosed in the 8th embodiment, an image capturing unit 100a, an image capturing unit 100b, an image capturing unit 100c and a display unit 201. As shown in FIG. 16, the image capturing unit 100, the image capturing unit 100a and the image capturing unit 100b are disposed on the same side of the electronic device 200 and face the same side, and each of the image capturing units 100, 100a and 100b has a single focal point. As shown in FIG. 17, the image capturing unit 100c and the display unit 201 are disposed on the opposite side of the electronic device 200, such that the image capturing unit 100c can be a front-facing camera of the electronic device 200 for taking selfies, but the present disclosure is not limited thereto. Furthermore, each of the image capturing units 100a, 100b and 100c can include the photographing optical lens assembly of the present disclosure and can have a configuration similar to that of the image capturing unit 100. In detail, each of the image capturing units 100a, 100b and 100c can include a lens unit, a driving device, an image sensor and an image stabilizer, and each of the lens unit can include a photographing optical lens assembly such as the photographing optical lens assembly of the present disclosure, a barrel and a holder member for holding the photographing optical lens assembly.

The image capturing unit 100 is a wide-angle image capturing unit, the image capturing unit 100a is a telephoto image capturing unit, the image capturing unit 100b is an ultra-wide-angle image capturing unit, and the image capturing unit 100c is a wide-angle image capturing unit. In this embodiment, the image capturing units 100, 100a and 100b have different fields of view, such that the electronic device 200 can have various magnification ratios so as to meet the requirement of optical zoom functionality. Moreover, as shown in FIG. 17, the image capturing unit 100c can have a non-circular opening, and the lens barrel or the lens elements in the image capturing unit 100c can have one or more trimmed edges at outer diameter positions thereof for corresponding to the non-circular opening. Therefore, it is favorable for further reducing the length of the image capturing unit 100c along single axis, thereby reducing the overall size of the lens, increasing the area ratio of the display unit 201 with respect to the electronic device 200, reducing the thickness of the electronic device 200, and achieving compactness of the overall module. In this embodiment, the electronic device 200 includes multiple image capturing units 100, 100a, 100b and 100c, but the present disclosure is not limited to the number and arrangement of image capturing units.

### 10th Embodiment

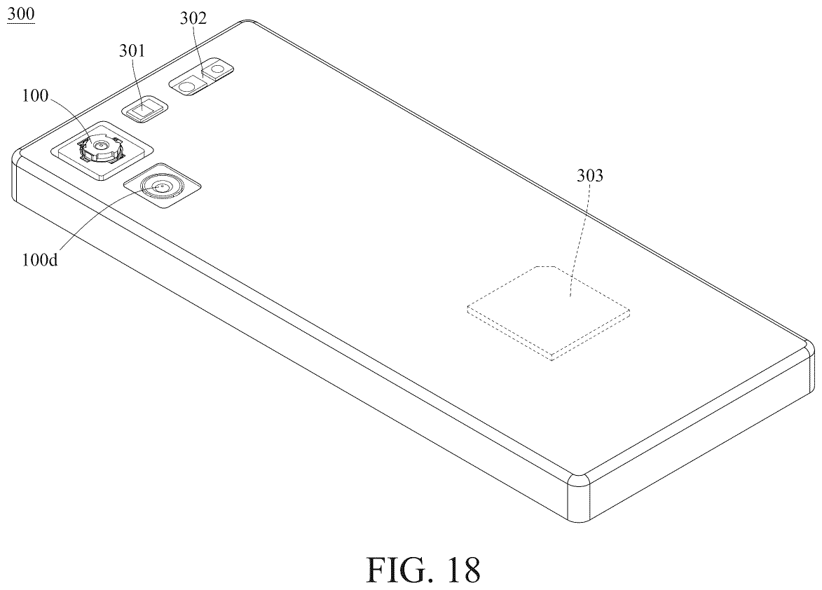

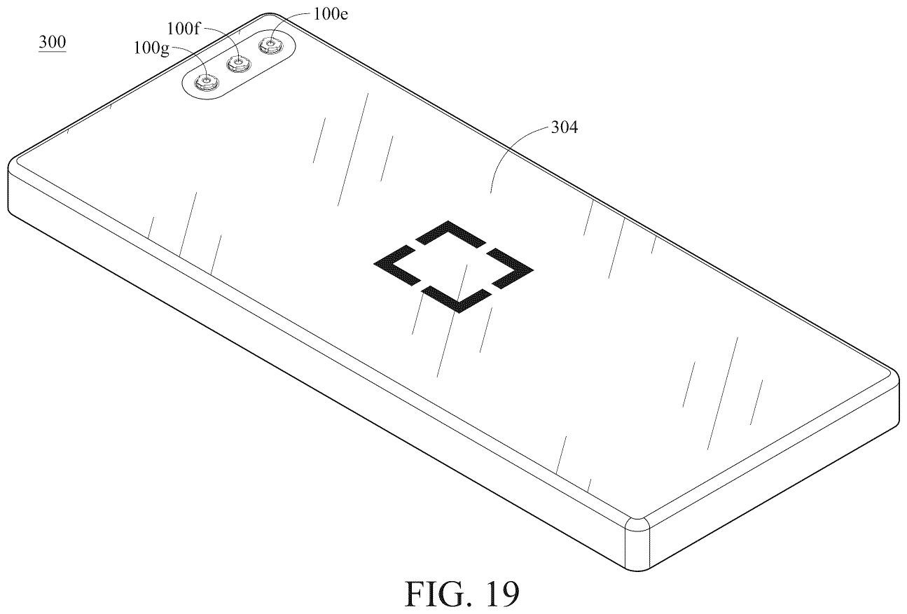

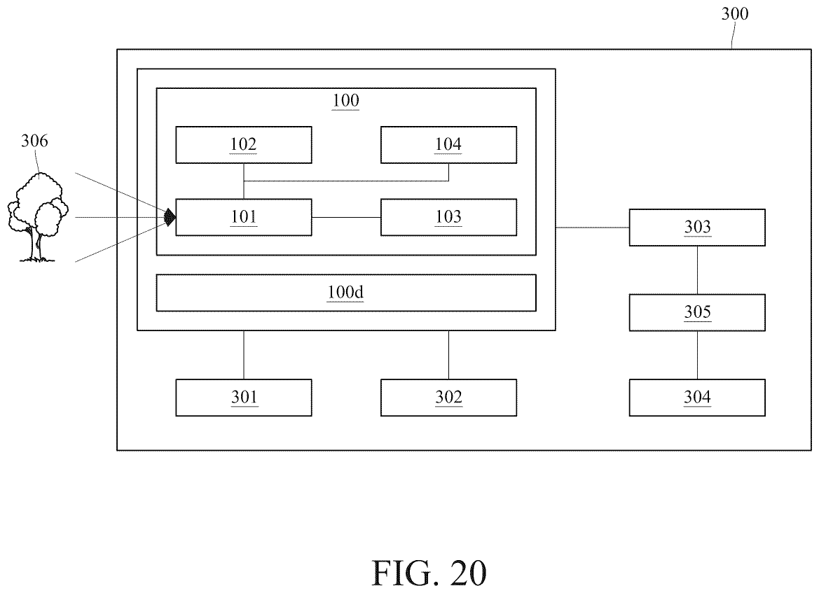

FIG. 18 is one perspective view of an electronic device according to the 10th embodiment of the present disclosure. FIG. 19 is another perspective view of the electronic device in FIG. 18. FIG. 20 is a block diagram of the electronic device in FIG. 18.

In this embodiment, an electronic device 300 is a smartphone including the image capturing unit 100 disclosed in the 8th embodiment, an image capturing unit 100d, an image capturing unit 100e, an image capturing unit 100f, an image capturing unit 100g, a flash module 301, a focus assist module 302, an image signal processor 303, a display module 304 and an image software processor 305. The image capturing unit 100 and the image capturing unit 100d are disposed on the same side of the electronic device 300. The focus assist module 302 can be a laser rangefinder or a ToF (time of flight) module, but the present disclosure is not limited thereto. The image capturing unit 100e, the image capturing unit 100f, the image capturing unit 100g and the display module 304 are disposed on the opposite side of the electronic device 300, and the display module 304 can be a user interface, such that the image capturing units 100e, 100f, 100g can be front-facing cameras of the electronic device 300 for taking selfies, but the present disclosure is not limited thereto. Furthermore, each of the image capturing units 100d, 100e, 100f and 100g can include the photographing optical lens assembly of the present disclosure and can have a configuration similar to that of the image capturing unit 100. In detail, each of the image capturing units 100d, 100e, 100f and 100g can include a lens unit, a driving device, an image sensor and an image stabilizer, and each of the lens unit can include a photographing optical lens assembly such as the photographing optical lens assembly of the present disclosure, a barrel and a holder member for holding the photographing optical lens assembly.

The image capturing unit 100 is a wide-angle image capturing unit, the image capturing unit 100d is an ultra-wide-angle image capturing unit, the image capturing unit 100e is a wide-angle image capturing unit, the image capturing unit 100f is an ultra-wide-angle image capturing unit, and the image capturing unit 100g is a ToF image capturing unit. In this embodiment, the image capturing units 100 and 100d have different fields of view, such that the electronic device 300 can have various magnification ratios so as to meet the requirement of optical zoom functionality. In addition, the image capturing unit 100g can determine depth information of the imaged object. In this embodiment, the electronic device 300 includes multiple image capturing units 100, 100d, 100e, 100f and 100g, but the present disclosure is not limited to the number and arrangement of image capturing units.

When a user captures images of an object 306, the light rays converge in the image capturing unit 100 or the image capturing unit 100d to generate images, and the flash module 301 is activated for light supplement. The focus assist module 302 detects the object distance of the imaged object 306 to achieve fast auto focusing. The image signal processor 303 is configured to optimize the captured image to improve image quality. The light beam emitted from the focus assist module 302 can be either conventional infrared or laser. In addition, the light rays may converge in the image capturing unit 100e, 100f or 100g to generate images. The display module 304 can include a touch screen, and the user is able to interact with the display module 304 and the image software processor 305 having multiple functions to capture images and complete image processing. Alternatively, the user may capture images via a physical button. The image processed by the image software processor 305 can be displayed on the display module 304.

### 11th Embodiment

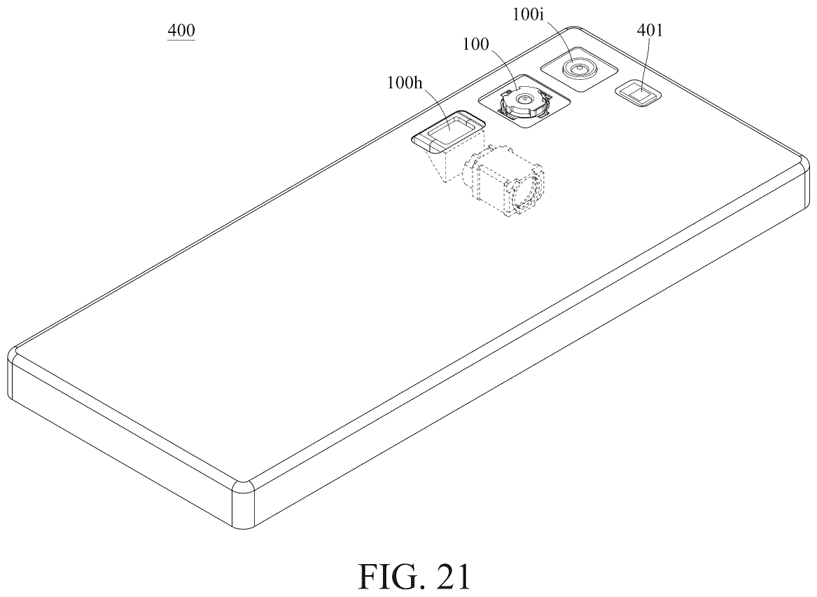

FIG. 21 is one perspective view of an electronic device according to the 11th embodiment of the present disclosure.

In this embodiment, an electronic device 400 is a smartphone including the image capturing unit 100 disclosed in the 8th embodiment, an image capturing unit 100h, an image capturing unit 100i, a flash module 401, a focus assist module, an image signal processor, a display module and an image software processor (not shown). The image capturing unit 100, the image capturing unit 100h and the image capturing unit 100i are disposed on the same side of the electronic device 400, while the display module is disposed on the opposite side of the electronic device 400. Furthermore, each of the image capturing units 100h and 100i can include the photographing optical lens assembly of the present disclosure and can have a configuration similar to that of the image capturing unit 100, and the details in this regard will not be provided again.

The image capturing unit 100 is a wide-angle image capturing unit, the image capturing unit 100h is a telephoto image capturing unit, and the image capturing unit 100i is an ultra-wide-angle image capturing unit. In this embodiment, the image capturing units 100, 100h and 100i have different fields of view, such that the electronic device 400 can have various magnification ratios so as to meet the requirement of optical zoom functionality. Moreover, the image capturing unit 100h can be a telephoto image capturing unit having a light-folding element configuration, such that the total track length of the image capturing unit 100h is not limited by the thickness of the electronic device 400. Moreover, the light-folding element configuration of the image capturing unit 100h can be similar to, for example, one of the structures shown in FIG. 31 to FIG. 33, which can be referred to foregoing descriptions corresponding to FIG. 31 to FIG. 33, and the details in this regard will not be provided again. In this embodiment, the electronic device 400 includes multiple image capturing units 100, 100h and 100i, but the present disclosure is not limited to the number and arrangement of image capturing units. When a user captures images of an object, light rays converge in the image capturing unit 100, 100h or 100i to generate images, and the flash module 401 is activated for light supplement. Further, the subsequent processes are performed in a manner similar to the abovementioned embodiment, so the details in this regard will not be provided again.

### 12th Embodiment

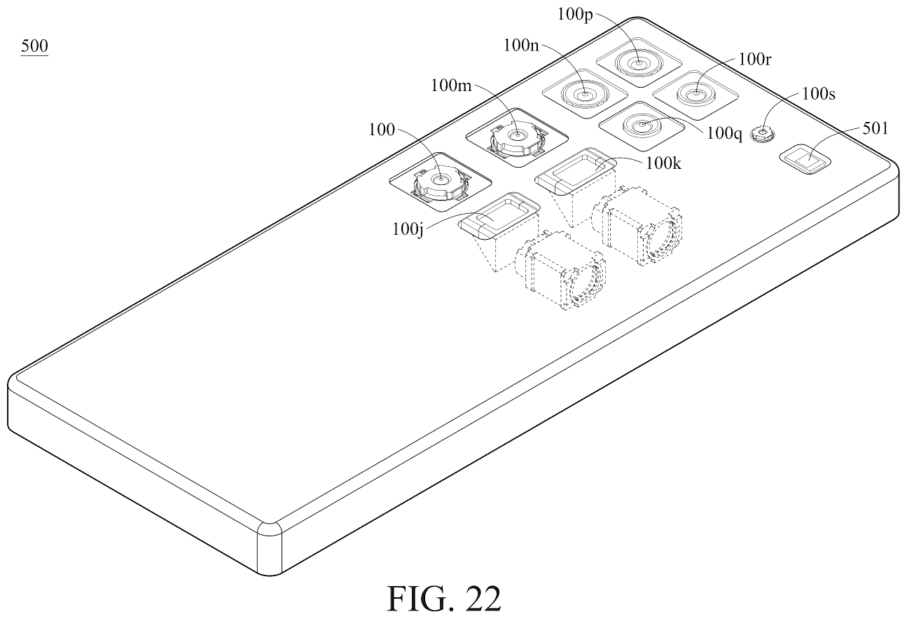

FIG. 22 is one perspective view of an electronic device according to the 12th embodiment of the present disclosure.

In this embodiment, an electronic device 500 is a smartphone including the image capturing unit 100 disclosed in the 8th embodiment, an image capturing unit 100j, an image capturing unit 100k, an image capturing unit 100m, an image capturing unit 100n, an image capturing unit 100p, an image capturing unit 100q, an image capturing unit 100r, an image capturing unit 100s, a flash module 501, a focus assist module, an image signal processor, a display module and an image software processor (not shown). The image capturing units 100, 100j, 100k, 100m, 100n, 100p, 100q, 100r and 100s are disposed on the same side of the electronic device 500, while the display module is disposed on the opposite side of the electronic device 500. Furthermore, each of the image capturing units 100j, 100k, 100m, 100n, 100p, 100q, 100r and 100s can include the photographing optical lens assembly of the present disclosure and can have a configuration similar to that of the image capturing unit 100, and the details in this regard will not be provided again.

The image capturing unit 100 is a wide-angle image capturing unit, the image capturing unit 100j is a telephoto image capturing unit, the image capturing unit 100k is a telephoto image capturing unit, the image capturing unit 100m is a wide-angle image capturing unit, the image capturing unit 100n is an ultra-wide-angle image capturing unit, the image capturing unit 100p is an ultra-wide-angle image capturing unit, the image capturing unit 100q is a telephoto image capturing unit, the image capturing unit 100r is a telephoto image capturing unit, and the image capturing unit 100s is a ToF image capturing unit. In this embodiment, the image capturing units 100, 100j, 100k, 100m, 100n, 100p, 100q and 100r have different fields of view, such that the electronic device 500 can have various magnification ratios so as to meet the requirement of optical zoom functionality. Moreover, each of the image capturing units 100j and 100k can be a telephoto image capturing unit having a light-folding element configuration. Moreover, the light-folding element configuration of each of the image capturing unit 100j and 100k can be similar to, for example, one of the structures shown in FIG. 31 to FIG. 33, which can be referred to foregoing descriptions corresponding to FIG. 31 to FIG. 33, and the details in this regard will not be provided again. In addition, the image capturing unit 100s can determine depth information of the imaged object. In this embodiment, the electronic device 500 includes multiple image capturing units 100, 100j, 100k, 100m, 100n, 100p, 100q, 100r and 100s, but the present disclosure is not limited to the number and arrangement of image capturing units. When a user captures images of an object, the light rays converge in the image capturing unit 100, 100j, 100k, 100m, 100n, 100p, 100q, 100r or 100s to generate images, and the flash module 501 is activated for light supplement. Further, the subsequent processes are performed in a manner similar to the abovementioned embodiments, and the details in this regard will not be provided again.

### 13th Embodiment

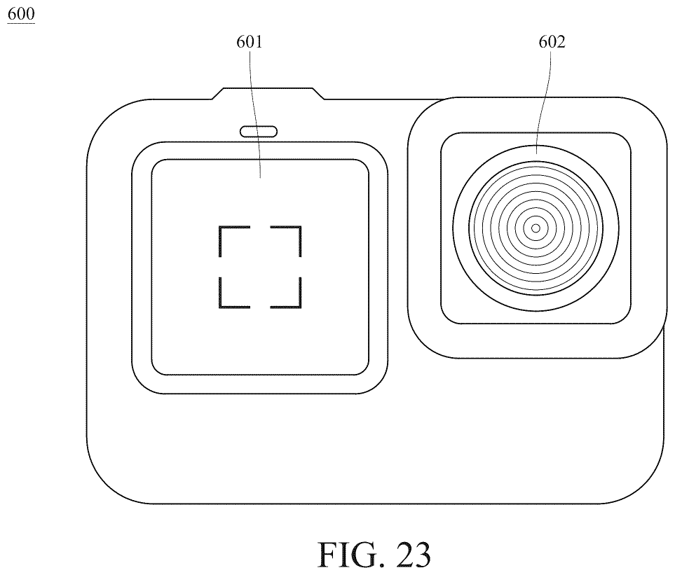

FIG. 23 is a schematic view of an electronic device according to the 13th embodiment of the present disclosure.

In this embodiment, an electronic device 600 may be a small-size camera, such as an action camera. The electronic device 600 includes a display unit 601 and an image capturing unit 602. The image capturing unit 602 is electrically connected to the display unit 601. The image capturing unit 602 includes the photographing optical lens assembly disclosed in the 1st embodiment. The image capturing unit 602 can be a wide-angle image capturing unit. The image capturing unit 602, which is similar to the image capturing unit 100, can further include a barrel, a holder member or a combination thereof. The electronic device 600 captures an image by the image capturing unit 602. Preferably, the electronic device may further include a control unit, a display unit, a storage unit, a random access memory unit (RAM) or a combination thereof.

### 14th Embodiment

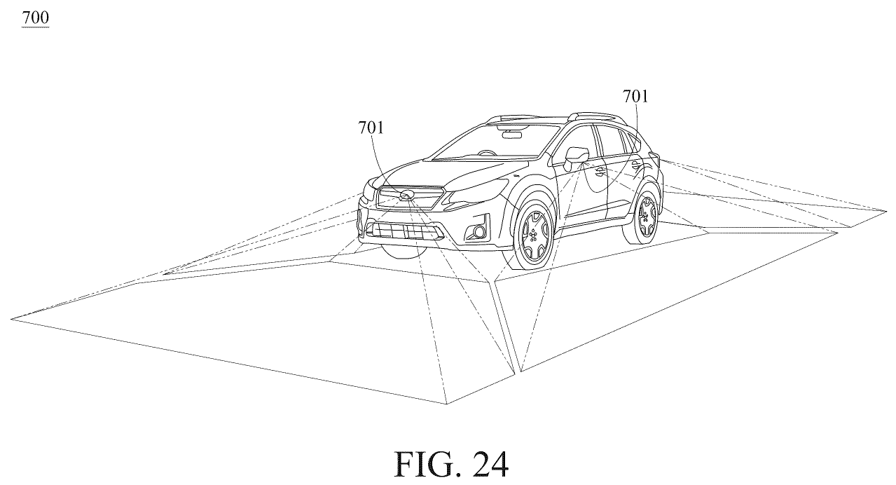

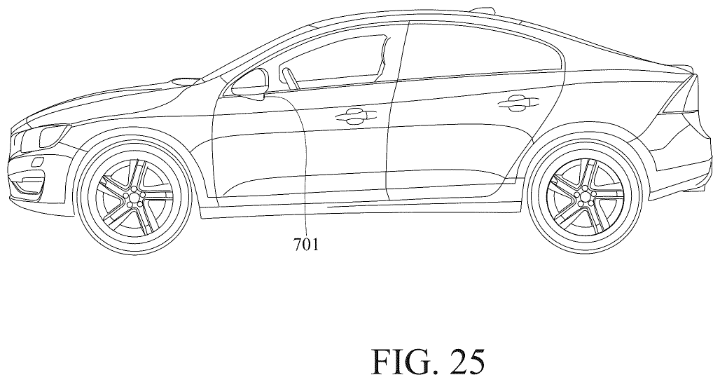

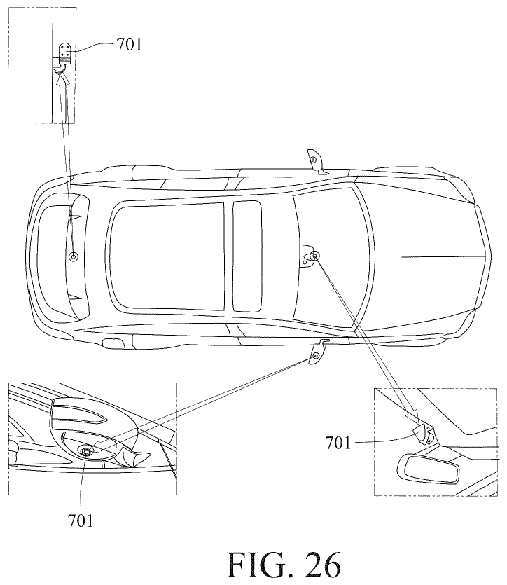

FIG. 24 is a perspective view of an electronic device according to the 14th embodiment of the present disclosure. FIG. 25 is a side view of the electronic device in FIG. 24. FIG. 26 is a top view of the electronic device in FIG. 24.

In this embodiment, an electronic device 700 is a mobile vehicle, such as a car. The electronic device 700 includes a plurality of image capturing units 701, and each of the image capturing units 701 includes, for example, the photographing optical lens assembly of the present disclosure. The image capturing units 701 can be served as, for example, panoramic view car cameras, dashboard cameras and vehicle backup cameras. The image capturing units 701 can be wide-angle image capturing units.

As shown in FIG. 24 to FIG. 26, the image capturing units 701 are, for example, disposed at the front side, the rear side, the lateral sides, inner side or on the backmirror of the car to capture peripheral images of the car, which is favorable for obtaining external traffic information so as to achieve an advanced driver-assistance function. In addition, the image software processor may stitch the peripheral images into one panoramic view image for the driver's checking every corner surrounding the car, thereby assisting in parking and driving.

As shown in FIG. 25, the image capturing units 701 are, for example, disposed on the lower portion of the side mirrors for capturing image information of the left and right lanes. As shown in FIG. 26, the image capturing units 701 can also be, for example, disposed on the lower portion of the side mirrors and inside the front and rear windshields for providing external information to the driver, and also providing more viewing angles so as to reduce blind spots, thereby improving driving safety. Please be noted the arrangement of the image capturing units 701 in the drawings is only exemplary, and the number, the positions and the image capturing directions of the image capturing units 701 can be adjusted according to actual requirements.

### 15th Embodiment

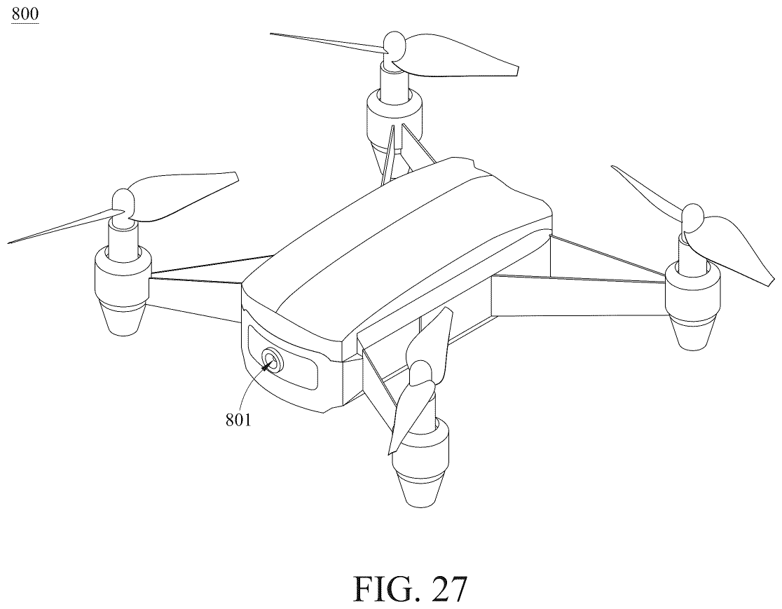

FIG. 27 is a schematic view of an electronic device according to the 15th embodiment of the present disclosure.

In this embodiment, an electronic device 800 may be a lightweight unmanned aerial vehicle, such as a drone camera. The electronic device 800 includes an image capturing unit 801. The image capturing unit 801 includes the photographing optical lens assembly disclosed in the 1st embodiment. The image capturing unit 801 can be a wide-angle image capturing unit. The image capturing unit 801, which is similar to the image capturing unit 100, can further include a barrel, a holder member or a combination thereof. The electronic device 800 captures an image by the image capturing unit 801. Preferably, the electronic device may further include a control unit, a display unit, a storage unit, a random access memory unit (RAM) or a combination thereof.

### 16th Embodiment

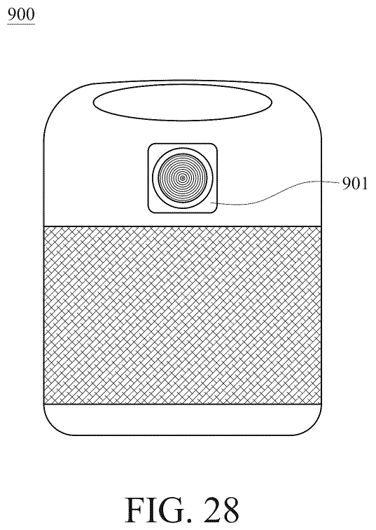

FIG. 28 is a schematic view of an electronic device according to the 16th embodiment of the present disclosure.

In this embodiment, an electronic device 900 may be a sound box, such as a smart speaker. The electronic device 900 includes an image capturing unit 901. The image capturing unit 901 includes the photographing optical lens assembly disclosed in the 1st embodiment. The image capturing unit 901 can be a wide-angle image capturing unit. The image capturing unit 901, which is similar to the image capturing unit 100, can further include a barrel, a holder member or a combination thereof. The electronic device 900 captures an image by the image capturing unit 901. Preferably, the electronic device may further include a control unit, a display unit, a storage unit, a random access memory unit (RAM) or a combination thereof.

The smartphone, the camera, the mobile vehicle, the unmanned aerial vehicle and the sound box in several embodiments are only exemplary for showing the image capturing unit of the present disclosure installed in an electronic device, and the present disclosure is not limited thereto. The image capturing unit can be optionally applied to optical systems with a movable focus. Furthermore, the photographing optical lens assembly of the image capturing unit features good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multi-camera devices, image recognition systems, motion sensing input devices, wearable devices and other electronic imaging devices.

The foregoing description, for the purpose of explanation, has been described with reference to specific embodiments. It is to be noted that TABLES 1A-7D show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A photographing optical lens assembly comprising eight lens elements, the eight lens elements being, in order from an object side to an image side along an optical path, a first lens element, a second lens element, a third lens element, a fourth lens element, a fifth lens element, a sixth lens element, a seventh lens element and an eighth lens element, and each of the eight lens elements having an object-side surface facing toward the object side and an image-side surface facing toward the image side;
wherein the first lens element has negative refractive power, the image-side surface of the second lens element is concave in a paraxial region thereof, the image-side surface of the fourth lens element is convex in a paraxial region thereof, the fifth lens element has positive refractive power, the object-side surface of the fifth lens element is convex in a paraxial region thereof, the image-side surface of the fifth lens element is convex in a paraxial region thereof, the sixth lens element has negative refractive power, the image-side surface of the sixth lens element is concave in a paraxial region thereof, the seventh lens element has positive refractive power, the image-side surface of the eighth lens element is concave in a paraxial region thereof, and the image-side surface of the eighth lens element has at least one inflection point;
wherein a curvature radius of the object-side surface of the sixth lens element is R11, a curvature radius of the image-side surface of the sixth lens element is R12, an axial distance between the object-side surface of the first lens element and an image surface measured at a reference wavelength of d-line is TLd, a maximum image height of the photographing optical lens assembly is ImgH, a focal length of the photographing optical lens assembly measured at the reference wavelength of d-line is fd, a central thickness of the first lens element is CT1, a central thickness of the third lens element is CT3, a central thickness of the seventh lens element is CT7, an axial distance between the second lens element and the third lens element is T23, and the following conditions are satisfied:
$$0 < ( R 11 + R 12 ) / ( R 11 - R 12 ) < 1.5 ;$$
$$4. < TLd / ImgH < 6.5 ;$$
$$6. < TLd / fd < 12 \text{.00} ;$$
$$0.1 < CT 1 / CT 7 < 0.8 ; and$$
$$0.6 < T 23 / CT 3 < 2.00 .$$

2. The photographing optical lens assembly of claim 1, wherein the second lens element has negative refractive power, and the fourth lens element has positive refractive power;
wherein the axial distance between the object-side surface of the first lens element and the image surface measured at the reference wavelength of d-line is TLd, the maximum image height of the photographing optical lens assembly is ImgH, and the following condition is satisfied:
$$4.5 < TLd / ImgH < 6.3 .$$

3. The photographing optical lens assembly of claim 1, wherein the image-side surface of the eighth lens element has at least one critical point in an off-axis region thereof;
wherein the axial distance between the object-side surface of the first lens element and the image surface measured at the reference wavelength of d-line is TLd, the focal length of the photographing optical lens assembly measured at the reference wavelength of d-line is fd, and the following condition is satisfied:
$$7. < T L d / f d < 10.00 .$$

4. The photographing optical lens assembly of claim 1, wherein the object-side surface of the sixth lens element is concave in a paraxial region thereof,
wherein the curvature radius of the object-side surface of the sixth lens element is R11, the curvature radius of the image-side surface of the sixth lens element is R12, and the following condition is satisfied:
$$0.1 < ( R 11 + R 12 ) / ( R 11 - R 12 ) < 0.70 .$$

5. The photographing optical lens assembly of claim 1, wherein the object-side surface of the first lens element is convex in a paraxial region thereof;
wherein the central thickness of the first lens element is CT1, the central thickness of the third lens element is CT3, the central thickness of the seventh lens element is CT7, the axial distance between the second lens element and the third lens element is T23, and the following conditions are satisfied:
$$0.2 < C T 1 / C T 7 < 0.65 ; and$$
$$0.7 < T 23 / CT 3 < 1.8 .$$

6. The photographing optical lens assembly of claim 1, wherein a focal length of the second lens element measured at the reference wavelength of d-line is f2d, a focal length of the sixth lens element measured at the reference wavelength of d-line is f6d, and the following condition is satisfied:
$$1. 50 < \vert f 2 d / f 6 d \vert < 4.00 .$$

7. The photographing optical lens assembly of claim 1, wherein a curvature radius of the object-side surface of the fifth lens element is R9, a curvature radius of the image-side surface of the eighth lens element is R16, and the following condition is satisfied:
$$0 < ( R 9 - R 16 ) / ( R 9 + R 16 ) < 0.50 .$$

8. The photographing optical lens assembly of claim 1, wherein the image-side surface of the first lens element is concave in a paraxial region thereof, the object-side surface of the second lens element is convex in a paraxial region thereof, the image-side surface of the third lens element is convex in a paraxial region thereof, the object-side surface of the sixth lens element is concave in a paraxial region thereof, and the object-side surface of the seventh lens element is convex in a paraxial region thereof.

9. The photographing optical lens assembly of claim 1, wherein an axial distance between the object-side surface of the first lens element and the image-side surface of the eighth lens element is TD, an axial distance between the image-side surface of the eighth lens element and the image surface measured at the reference wavelength of d-line is BLd, and the following condition is satisfied:
$$8. 00 < T D / B L d < 18. .$$

10. The photographing optical lens assembly of claim 1, wherein an axial distance between the first lens element and the second lens element is T12, the axial distance between the second lens element and the third lens element is T23, and the following condition is satisfied:
$$0. 20 < T 12 / T 23 < 1.8 .$$

11. The photographing optical lens assembly of claim 1, wherein the focal length of the photographing optical lens assembly measured at the reference wavelength of d-line is fd, a central thickness of the eighth lens element is CT8, and the following condition is satisfied:
$$0.5 < fd / CT 8 < 2. .$$

12. The photographing optical lens assembly of claim 1, wherein an f-number of the photographing optical lens assembly measured at the reference wavelength of d-line is Fnod, half of a maximum field of view of the photographing optical lens assembly measured at the reference wavelength of d-line is HFOVd, and the following conditions are satisfied:
$$\begin{matrix}1.5 < Fnod < 2. ; and \\ 65. degrees < HFOVd < 90. degrees .\end{matrix}$$

13. The photographing optical lens assembly of claim 1, wherein a displacement in parallel with an optical axis from an axial vertex on the object-side surface of the second lens element to a maximum effective radius position on the object-side surface of the second lens element measured at the reference wavelength of d-line is Sag2R1d, a central thickness of the second lens element is CT2, and the following condition is satisfied:
$$0.5 < Sag 2 R 1 d / CT 2 < 2.5 .$$

14. The photographing optical lens assembly of claim 1, wherein a maximum effective radius of the object-side surface of the first lens element measured at the reference wavelength of d-line is Y1R1d, a maximum effective radius of the object-side surface of the fifth lens element measured at the reference wavelength of d-line is Y5R1d, the maximum image height of the photographing optical lens assembly is ImgH, and the following conditions are satisfied:
$$\begin{matrix}1.5 < Y 1 R 1 d / ImgH < 2.5 ; and \\ 3. < Y 1 R 1 d / Y 5 R 1 d < 5. .\end{matrix}$$

15. An image capturing unit, comprising:
the photographing optical lens assembly of claim 1; and
an image sensor disposed on the image surface of the photographing optical lens assembly.

16. An electronic device, comprising:
the image capturing unit of claim 15.

17. A photographing optical lens assembly comprising eight lens elements, the eight lens elements being, in order from an object side to an image side along an optical path, a first lens element, a second lens element, a third lens element, a fourth lens element, a fifth lens element, a sixth lens element, a seventh lens element and an eighth lens element, and each of the eight lens elements having an object-side surface facing toward the object side and an image-side surface facing toward the image side;
wherein the first lens element has negative refractive power, the image-side surface of the second lens element is concave in a paraxial region thereof, the fourth lens element has positive refractive power, the object-side surface of the fifth lens element is convex in a paraxial region thereof, the sixth lens element has negative refractive power, the object-side surface of the sixth lens element is concave in a paraxial region thereof, the image-side surface of the sixth lens element is concave in a paraxial region thereof, the seventh lens element has positive refractive power, the image-side surface of the eighth lens element is concave in a paraxial region thereof, and the image-side surface of the eighth lens element has at least one inflection point;
wherein a curvature radius of the object-side surface of the first lens element is R1, a curvature radius of the object-side surface of the sixth lens element is R11, a curvature radius of the image-side surface of the sixth lens element is R12, a curvature radius of the object-side surface of the eighth lens element is R15, a curvature radius of the image-side surface of the eighth lens element is R16, an axial distance between the object-side surface of the first lens element and an image surface measured at a reference wavelength of d-line is TLd, a maximum image height of the photographing optical lens assembly is ImgH, a focal length of the photographing optical lens assembly measured at the reference wavelength of d-line is fd, a focal length of the first lens element measured at the reference wavelength of d-line is f1d, a focal length of the second lens element measured at the reference wavelength of d-line is f2d, a focal length of the third lens element measured at the reference wavelength of d-line is f3d, a focal length of the fourth lens element measured at the reference wavelength of d-line is f4d, a focal length of the fifth lens element measured at the reference wavelength of d-line is f5d, a focal length of the sixth lens element measured at the reference wavelength of d-line is f6d, a focal length of the seventh lens element measured at the reference wavelength of d-line is f7d, a focal length of the eighth lens element measured at the reference wavelength of d-line is f8d, a focal length of the i-th lens element measured at the reference wavelength of d-line is fid, and the following conditions are satisfied:
$$\begin{matrix}0 < ( R 11 + R 12 ) / ( R 11 - R 12 ) < 0 \text{.90} ; \\ 4. < TLd / ImgH < 6.5 ; \\ 1. > \sum \vert fd / fid \vert < 4. , wherein i = 1 , 2 , 3 , 4 , 5 , 6 , 7 , and 8 ; \\ 0.65 < \vert fd / R 15 \vert + \vert fd / R 16 \vert < 2. ; and \\ 0.25 < \vert f 1 d / R 1 \vert < 1. .\end{matrix}$$

18. The photographing optical lens assembly of claim 17, wherein the second lens element has negative refractive power, and the fifth lens element has positive refractive power;
wherein the curvature radius of the object-side surface of the sixth lens element is R11, the curvature radius of the image-side surface of the sixth lens element is R12, and the following condition is satisfied:
$$0.1 < ( R 11 + R 12 ) / ( R 11 - R 12 ) < 0.65 .$$

19. The photographing optical lens assembly of claim 17, wherein the object-side surface of the second lens element is convex in a paraxial region thereof, and the image-side surface of the third lens element is convex in a paraxial region thereof;
wherein the focal length of the photographing optical lens assembly measured at the reference wavelength of d-line is fd, the curvature radius of the object-side surface of the eighth lens element is R15, the curvature radius of the image-side surface of the eighth lens element is R16, and the following condition is satisfied:
$$0.8 < \vert fd / R 15 \vert + \vert fd / R 16 \vert < 1.8 .$$

20. The photographing optical lens assembly of claim 17, wherein the first lens element is made of glass material;
wherein the focal length of the first lens element measured at the reference wavelength of d-line is f1d, the curvature radius of the object-side surface of the first lens element is R1, and the following condition is satisfied:
$$0.35 < \vert f 1 d / R 1 \vert < 0.85 .$$

21. The photographing optical lens assembly of claim 17, wherein the third lens element has positive refractive power;
wherein a curvature radius of the object-side surface of the third lens element is R5, a curvature radius of the image-side surface of the third lens element is R6, and the following condition is satisfied:
$$0.2 < ( R 5 + R 6 ) / ( R 5 - R 6 ) < 2. .$$

22. The photographing optical lens assembly of claim 17, wherein the curvature radius of the object-side surface of the sixth lens element is R11, the focal length of the photographing optical lens assembly measured at the reference wavelength of d-line is fd, and the following condition is satisfied:
$$1.8 < \vert R 11 / fd \vert < 5. .$$

23. The photographing optical lens assembly of claim 17, wherein a central thickness of the first lens element is CT1, an axial distance between the second lens element and the third lens element is T23, and the following condition is satisfied:
$$0.1 < CT 1 / T 23 < 1. .$$

24. The photographing optical lens assembly of claim 17, wherein an Abbe number of the second lens element is V2, an Abbe number of the third lens element is V3, and the following condition is satisfied:
$$1.4 < V 2 / V 3 < 4. .$$

25. The photographing optical lens assembly of claim 17, wherein a refractive index of the eighth lens element measured at the reference wavelength of d-line is N8d, and the following condition is satisfied:
$$1.5 < N 8 d < 1.6 .$$

26. The photographing optical lens assembly of claim 17, wherein the curvature radius of the image-side surface of the sixth lens element is R12, a curvature radius of the object-side surface of the seventh lens element is R13, an axial distance between the sixth lens element and the seventh lens element is T67, and the following condition is satisfied:
$$0.01 < \vert R 12 - R 13 \vert / T 67 < 10. .$$

27. The photographing optical lens assembly of claim 17, wherein the eight lens elements comprise at least one positive lens element, and an Abbe number of the at least one positive lens element is smaller than 30.0.

28. The photographing optical lens assembly of claim 17, wherein the curvature radius of the object-side surface of the first lens element is R1, the curvature radius of the object-side surface of the sixth lens element is R11, the curvature radius of the image-side surface of the sixth lens element is R12, the curvature radius of the object-side surface of the eighth lens element is R15, the curvature radius of the image-side surface of the eighth lens element is R16, the axial distance between the object-side surface of the first lens element and the image surface measured at the reference wavelength of d-line is TLd, the maximum image height of the photographing optical lens assembly is ImgH, a central thickness of the first lens element is CT1, a central thickness of the third lens element is CT3, a central thickness of the seventh lens element is CT7, an axial distance between the second lens element and the third lens element is T23, the focal length of the photographing optical lens assembly measured at the reference wavelength of d-line is fd, the focal length of the first lens element measured at the reference wavelength of d-line is f1d, the focal length of the second lens element measured at the reference wavelength of d-line is f2d, the focal length of the third lens element measured at the reference wavelength of d-line is f3d, the focal length of the fourth lens element measured at the reference wavelength of d-line is f4d, the focal length of the fifth lens element measured at the reference wavelength of d-line is f5d, the focal length of the sixth lens element measured at the reference wavelength of d-line is f6d, the focal length of the seventh lens element measured at the reference wavelength of d-line is f7d, the focal length of the eighth lens element measured at the reference wavelength of d-line is f8d, the focal length of the i-th lens element measured at the reference wavelength of d-line is fid, and the following conditions are satisfied:
$$\begin{matrix}0.13 \leq ( R 11 + R 12 ) / ( R 11 - R 12 ) \leq 1.21 ; \\ 5. \leq TLd / ImgH \leq 6.07 ; \\ 7.72 \leq TLd / fd \leq 9.56 ; \\ 0.38 \leq CT 1 / CT 7 \leq 0.55 ; \\ 0.81 \leq T 23 / CT 3 \leq 1.44 ; \\ 2.16 \leq \sum \vert fd / fid \vert \leq 3.48 , wherein i = 1 , 2 , 3 , 4 , 5 , 6 , 7 and 8 ; \\ 0.97 \leq \vert fd / R 15 \vert + \vert fd / R 16 \vert \leq 1.54 ; and \\ 0.43 \leq \vert f 1 d / R 1 \vert \leq 0.72 .\end{matrix}$$
